(19) United States
(12) Patent Application Publication
(10) Pub. No.: US 2026/0243999 A1
(43) Pub. Date: Aug. 20, 2026

(54) OPTICAL SYSTEM AND CAMERA MODULE

(71) Applicant: LG INNOTEK CO., LTD., Seoul (KR)

(72) Inventor: Sung Min MOON, Seoul (KR)

(73) Assignee: LG INNOTEK CO., LTD., Seoul (KR)

(21) Appl. No.: 19/161,654

(22) PCT Filed: Feb. 29, 2024
(86) PCT No.: PCT/KR2024/002707

§ 371 Date: Sep. 2, 2025

(30) Foreign Application Priority Data
Mar. 3, 2023 (KR) 10-2023-0028695

(51) Int. Cl. G02B 13/00; G02B 9/38; G02B 9/50; G02B 9/56

(52) U.S. Cl. CPC G02B 13/004; G02B 9/38; G02B 9/50; G02B 9/56

(57) ABSTRACT

The optical system disclosed in an embodiment of the invention includes first to fourth lenses sequentially arranged from the object side. The object-side surface of the first lens has a convex shape on the optical axis, and the sensor-side surface of the fourth lens has a convex shape on the optical axis. The first lens is made of a glass material, and both the object-side and the sensor-side surfaces of the first lens are spherical. An optical axis distance from the object-side surface of the first lens to the surface of the image sensor is TTL, and the optical axis distance from the sensor-side surface of the fourth lens to the surface of the image sensor is BFL, an optical axis distance from the object-side surface of the first lens to the sensor-side surface of the fourth lens is TD. The optical system may satisfy the following Mathematical Formulas: 0.2<BFL/TTL<1 and 1<TTL/TD<2.

### TECHNICAL FIELD

An embodiment of the invention relates to an optical system and a camera module including the same.

### BACKGROUND ART

A camera module may perform a function of capturing an object and storing the captured object as an image or a video, and may be mounted in various applications. In particular, the camera module may be manufactured in a very small size and may be applied not only to portable devices such as smartphones, tablet PCs, and laptops, but also to moving objects such as drones and vehicles to provide various functions. For example, an optical system of the camera module may include an imaging lens for forming an image and an image sensor for converting the formed image into an electrical signal. At this time, the camera module may perform an autofocus (AF) function of automatically adjusting a distance between the image sensor and the imaging lens to align a focal length of the lens, and may perform a zooming function of increasing or decreasing a magnification of a distant object through a zoom lens to capture a zoom-up or zoom-out image. In addition, the camera module may adopt an image stabilization (IS) technology for compensating or preventing image shake caused by movement of the camera due to an unstable fixture or movement of a user.

The most important element for such a camera module to obtain an image is an imaging lens that forms the image. Recently, there has been increasing interest in high performance such as high definition and high resolution, and research has been conducted on optical systems including a plurality of lenses to realize this. For example, in order to implement a high-performance optical system, research has been conducted using a plurality of imaging lenses having positive (+) or negative (−) refractive power. The optical system including a plurality of lenses may have a set effective focal length (EFL). In this case, when the effective focal length (EFL) value is relatively large, a lens adjacent to an object side may have a large aperture, or the largest aperture among the plurality of lenses. Accordingly, since the lens adjacent to the object side has a relatively large size, there is a problem in that it is difficult to miniaturize the optical system.

The optical system including a plurality of lenses may have a relatively large height. For example, as the number of lenses increases, a distance from an image sensor to an object surface of a lens adjacent to an object may increase. Accordingly, an overall thickness of a device such as a smartphone in which the optical system is mounted may increase, and there is a problem in that it is difficult to miniaturize the optical system. A camera module for close-up photographing generally has a shorter TTL than a conventional camera module. In another example, a camera module for long-distance photographing generally has a longer TTL than a conventional camera module. However, since portable terminals have limited installation space for a camera module, it is difficult to mount a camera module for long-distance photographing or a zoom camera module capable of adjusting image magnification. Therefore, there is a demand for a new optical system capable of solving the above-described problems.

### DISCLOSURE

### Technical Problem

An embodiment may provide an optical system and a camera module having improved optical characteristics. An embodiment of the invention may provide an optical system that can be implemented in a small and compact form.

An embodiment of the invention may provide an optical system in which at least one lens among a plurality of lenses, which is adjacent to an object side or adjacent to an outer side of a terminal, has different lengths in a first direction and a second direction. That is, an optical system may be provided in which at least one or two or more of the lenses have different lengths in two orthogonal axial directions. An embodiment of the invention may provide an optical system applicable to a folded camera or a tele type having a thin thickness or height.

### Technical Solution

An optical system according to an embodiment of the invention may include a first lens to fourth lens arranged sequentially from the object side, wherein an object-side surface of the first lens has a convex shape on an optical axis, wherein a sensor-side surface of the fourth lens has a convex shape on the optical axis, the first lens is made of glass, the object-side surface and the sensor-side surface are spherical, wherein an optical axis distance from the object-side surface of the first lens to the surface of an image sensor is TTL, an optical axis distance from the sensor-side surface of the fourth lens to the surface of the image sensor is BFL, an optical axis distance from the object-side surface of the first lens to the sensor-side surface of the fourth lens is TD, and the following Mathematical Formula satisfies: 0.2<BFL/TTL<1 and 1<TTL/TD<2.

According to an embodiment of the invention, a center thickness of the fourth lens may be thicker than center thicknesses of the second and third lenses, a center thickness of the first lens is CT1, and a center thickness of the fourth lens is CT4, and a Mathematical Formula may satisfy: 1<CT1/CT4<3.1<CT1/CT4<3. Total focal length of the optical system is F, and a Mathematical Formula may satisfy: 0.5<TTL/F<1.5, and 7 mm<F<35 mm. Half of a diagonal length of the image sensor is ImgH, and a Mathematical Formula may satisfy: 3<TTL/ImgH<6, 1<BFL/ImgH<5. The fourth lens may have positive refractive power, and effective diameters of the object-side surface and the sensor-side surface of the fourth lens are CA41 and CA42, respectively, and a Mathematical Formula may satisfy: 5 mm< (CA41+CA42)<9 mm.

According to an embodiment of the invention, a maximum effective length in a first direction of the object-side surface and the sensor-side surface of the first lens may be greater than an effective diameter in the first direction of the object-side surface and the sensor-side surface of the fourth lens, and at least one of the first to third lenses may have a maximum effective length in a second direction orthogonal to the first direction smaller than the maximum effective length in the first direction, and the first direction and the second direction may be orthogonal to the optical axis.

According to an embodiment of the invention, a maximum effective length in a first direction of the object-side surface of the first lens is CA11x, and a maximum effective length in a second direction of the object-side surface of the first lens is CA11y, and a Mathematical Formula may satisfy: 0.55<CA11y/CA11x<0.98. An effective diameter of the sensor-side surface of the fourth lens is CA42, and a Mathematical Formula may satisfy: 0.50<CA42/CA11<0.9. A sum of center thicknesses of the first to third lenses is CT123, a center thickness of the fourth lens is CT4, a center distance between the third lens and the fourth lens is CG3, and a Mathematical Formula may satisfy: 0.1<CG3/CT123<0.5, 0.3<CG3/CT4<1.

According to an embodiment of the invention, the first to third lenses may have a meniscus shape convex toward an object side on the optical axis, and the fourth lens may have a meniscus shape convex toward a sensor side on the optical axis.

An optical system according to an embodiment of the invention may include a first lens having positive refractive power and a convex shape on an object-side surface, a second lens disposed on a sensor side of the first lens, a third lens disposed on a sensor side of the second lens, and a fourth lens disposed on a sensor side of the third lens, having positive refractive power and a convex shape on a sensor-side surface, and wherein the first to fourth lenses may be aligned along an optical axis.

According to an embodiment of the invention, the first lens may be a spherical lens made of glass, and the second to fourth lenses may be aspherical lenses having a material different from that of the first lens. A first optical path control member disposed on an object side of the first lens; and an image sensor disposed on a sensor side of the fourth lens. An optical axis distance from the object-side surface of the first lens to a surface of the image sensor is TTL, an optical axis distance from the sensor-side surface of the fourth lens to the surface of the image sensor is BFL, an optical axis distance from the object-side surface of the first lens to the sensor-side surface of the third lens is TLG1, a center thickness of the fourth lens is TLG2, and a Mathematical Formula may satisfy: 0.2<BFL/TTL<1, 2<TLG1/TLG2<5. A center distance between the third lens and the fourth lens is CG3, and a Mathematical Formula may satisfy: 7<BFL/CG3<12. The center distance between the third lens and the fourth lens may be the largest among center distances between other lenses, and the second and third lenses may have negative refractive power.

A camera module according to an embodiment of the invention may include: the optical system; and an optical filter disposed between the optical system and an image sensor, wherein at least one of lenses adjacent to an object among the lenses of the optical system has different lengths in two orthogonal directions, an optical axis distance from the object-side surface of the first lens to a surface of the image sensor is TTL, an optical axis distance from the sensor-side surface of the fourth lens to the surface of the image sensor is BFL, half of a diagonal length of the image sensor is ImgH, and a Mathematical Formula may satisfy: 1<BFL/ImgH<5, 3<TTL/ImgH<6.

### Advantageous Effects

The optical system and camera module according to an embodiment may have improved optical characteristics. Specifically, the optical system may have improved aberration characteristics and resolution as a plurality of lenses have set shapes, refractive powers, thicknesses, intervals, and the like. The optical system and camera module according to the embodiment may have improved distortion and aberration control characteristics and may provide good optical performance at both the central portion and the peripheral portion of the field of view (FOV). The optical system according to the embodiment may have improved optical characteristics and may have a large back focal length (BFL), thereby providing a telephoto optical system and a folded camera module including the same.

### DESCRIPTION OF DRAWINGS

FIG. 1 is a side cross-sectional view of a camera module having an optical system according to an embodiment of the invention.

FIG. 2 is a side cross-sectional view of a camera module having an optical system according to another embodiment of the invention.

FIG. 3 is a side cross-sectional view illustrating the optical systems of FIGS. 1 and 2.

FIG. 4 is an example of plan views of an object-side surface and a sensor-side surface of a first lens in the optical system of FIG. 3.

FIG. 5 is an example of plan views of an object-side surface and a sensor-side surface of a first lens in the optical system of FIG. 3.

FIG. 6 is an example of plan views of an object-side surface and a sensor-side surface of a first lens in the optical system of FIG. 3.

FIG. 7 is a table illustrating lens characteristics of the optical system of FIG. 3.

FIG. 8 is a table illustrating aspherical coefficients of lenses of the optical system of FIG. 3.

FIG. 9 is a graph illustrating data for ray aberrations of the optical system of FIG. 3.

FIG. 10 is a graph illustrating data for aberration characteristics of the optical system of FIG. 3.

FIG. 11 is an example of a portable terminal having an optical system according to an embodiment of the invention.

### BEST MODE

Hereinafter, preferred embodiments of the present invention will be described in detail with reference to the accompanying drawings. The technical idea of the present invention is not limited to some embodiments described, but may be implemented in various different forms, and within the scope of the technical idea of the present invention, one or more of the constituent components among embodiments may be selectively combined or replaced. In addition, the terms (including technical and scientific terms) used in the embodiments of the present invention, unless clearly and specifically defined otherwise, may be interpreted in meanings generally understood by those skilled in the art to which the present invention pertains, and generally used terms such as predefined terms may be interpreted in consideration of the contextual meaning of the related art.

The terms used in the embodiments of the present invention are for describing the embodiments and are not intended to limit the present invention. In the specification, unless otherwise specifically mentioned in the wording, the singular form may include the plural form, and when it is described as “at least one (or one or more) of A, B, and C,” it may include one or more of all combinations possible with A, B, and C. In addition, in describing the constituent components of the embodiments of the present invention, terms such as first, second, A, B, (a), and (b) may be used. These terms are only for distinguishing the constituent components from other constituent components, and are not to be construed as limiting the nature, order, or sequence of the constituent components. Furthermore, when a constituent component is described as being “connected,” “coupled,” or “joined” to another constituent component the constituent component may not only be directly connected, coupled, or connected to the other constituent component, but also may be connected, coupled, or connected due to another constituent component present between the constituent components. In addition, when each constituent component is described as being “on (above) or under (below)” another constituent component, “on (above) or under (below)” includes not only the case where the two constituent components are in direct contact, but also the case where one or more other constituent components are formed or disposed between the two constituent components. In addition, the expression “on (above) or under (below)” may include not only the upward direction but also the downward direction with respect to a reference constituent component.

In the description of the invention, the “object-side surface” may mean the surface of a lens facing an object side with reference to the optical axis (OA), and the “sensor-side surface” may mean the surface of the lens facing an imaging surface (image sensor) with reference to the optical axis. That one surface of the lens is convex may mean that the surface has a convex shape in the optical axis or paraxial region, and that one surface of the lens is concave may mean that the surface has a concave shape in the optical axis or paraxial region. The radius of curvature, center thickness, focal length, and spacing along the optical axis between lenses described in the table of lens data mean values along the optical axis and are in units of millimeters. The vertical direction may mean the direction perpendicular to the optical axis, and the edge of the lens or lens surface may mean the end of an effective region of the lens through which incident light passes. The effective diameter of a lens surface or the size of the radius of curvature may have a measurement error of up to about +0.4 mm depending on the measurement method. The paraxial region may mean a very narrow region near the optical axis, that is, a region in which the distance that a light ray deviates from the optical axis (OA) is nearly zero. Hereinafter, the optical axis may include the center of each lens or a very narrow region near the optical axis.

The optical system is composed of a plurality of lenses having refractive power. However, the optical system is not limited to being composed only of lenses having refractive power. For example, the optical system may include a stop (ST) for adjusting the amount of light. In addition, the optical system may include a filter for blocking infrared rays. In addition, the optical system may further include an image sensor (that is, an imaging device) for converting an image of a subject incident through the optical system into an electrical signal. In addition, the optical system may further include a spacer for adjusting a distance between lenses.

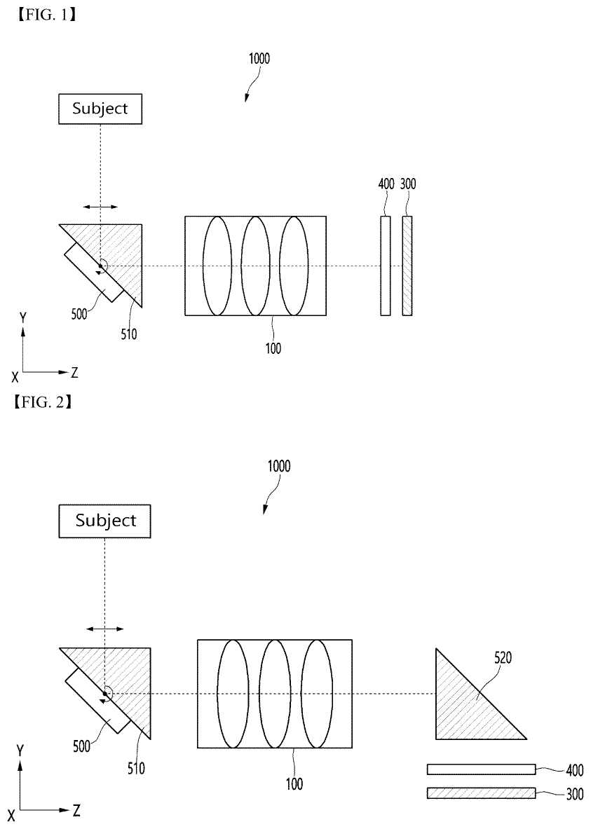

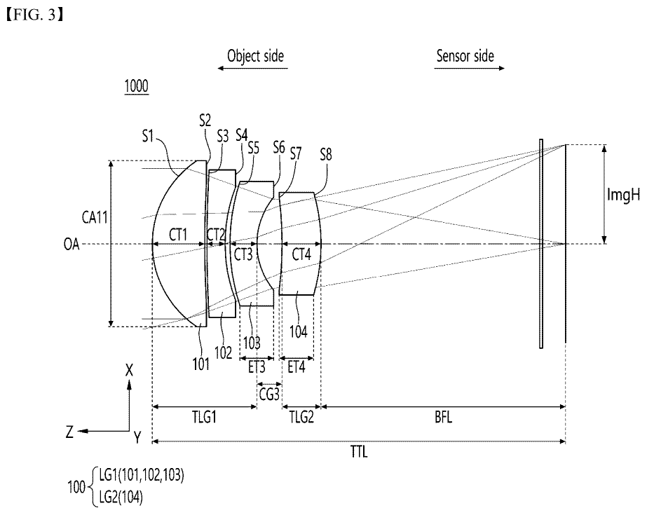

FIG. 1 is a side cross-sectional view of a camera module having an optical system according to an embodiment of the invention, and FIG. 2 is a side cross-sectional view of a camera module having an optical system according to another embodiment of the invention.

Referring to FIG. 1, an optical system 1000 or a camera module according to an embodiment may include a lens unit 100, an image sensor 300, and a first light path control member 510. The lens unit 100 may be disposed on the traveling path of light reflected from an object. The lens unit 100 may include at least one lens or a plurality of lenses. The lens unit 100 may be accommodated in a housing or a lens barrel. The plurality of lenses may be glass lenses, plastic lenses, or a combination of glass and plastic lenses. The plurality of lenses may be sequentially disposed along the optical axis of the lens unit 100 from the object side toward the upper direction. The optical axis of the lens unit 100 may be perpendicular to the top surface of the image sensor 300.

The lens unit 100 may control the path of light reflected from the object. For example, each of the plurality of lenses may have positive (+) or negative (−) refractive power, and may have a predetermined shape and thickness. Accordingly, the lens unit 100 may control the path of light reflected from the object by diffusing, scattering, refracting, or condensing the light. The lens unit 100 may have a predetermined field of view (FOV). In addition, the lens unit 100 may have a predetermined effective focal length (EFL). The effective focal length (EFL) of the lens unit 100 may be fixed within a predetermined range or may be provided as variable. The image sensor 300 may be disposed on the traveling path of light reflected from the object. For example, the lens unit 100 may be disposed between the object and the image sensor 300. The image sensor 300 may be disposed on a substrate (not shown). The substrate may be electrically connected to and physically support the image sensor 300. The substrate may be a circuit board. The substrate may include a wiring layer for supplying power to the image sensor 300 and may be a printed circuit board (PCB) formed of a plurality of resin layers. For example, the substrate may include at least one of a rigid PCB, a metal core PCB (MCPCB), a flexible PCB (FPCB), or a rigid-flexible PCB (RFPCB). The image sensor 300 may detect light reflected from the object and incident on the optical system 1000. The image sensor 300 may detect light passing through the lens unit 100. Specifically, the image sensor 300 may detect light sequentially passing through the plurality of lenses. The image sensor 300 may include a charge coupled device (CCD) or a complementary metal oxide semiconductor (CMOS).

The first light path control member 510 may be disposed on the traveling path of light reflected from the object. The first light path control member 510 may be disposed closer to the object than the lens unit 100. That is, from the object side toward the upper direction, the first light path control member 510, the lens unit 100, and the image sensor 300 may be sequentially disposed. The first light path control member 510 may change the path of light incident from the outside. The first light path control member 510 may include a mirror or a prism. For example, the first light path control member 510 may include a right-angle prism. When the first light path control member 510 includes a right-angle prism, it may reflect the path of light incident on the optical system 1000 and the camera module at a 90-degree angle. The first light path control member 510 may change the path of light reflected from the object to a predetermined direction. For example, the first light path control member 510 may reflect light incident on the first light path control member 510 in a first direction (Y-axis direction) and change the path of the light to a second direction (Z-axis direction) in which the plurality of lenses of the lens unit 100 are disposed.

When the optical system 1000 and the camera module include the first light path control member 510, they may be applied to a folded camera capable of reducing thickness. For example, when the optical system 1000 and the camera module do not include the first light path control member 510, the plurality of lenses of the lens unit 100 may be disposed extending in a direction perpendicular to the surface of the device. Accordingly, the optical system 1000 and the camera module including the plurality of lenses may have a high height in the direction perpendicular to the surface of the device, which may make it difficult to reduce the thickness of the camera module having the optical system 1000 and the device including the same. However, when the camera module includes the first light path control member 510, the camera module may change light incident in a direction perpendicular to the surface of the device into a direction parallel to the surface of the device. That is, the plurality of lenses of the lens unit 100 may be disposed extending in a direction parallel to the surface of the device, and the optical axis of the lens unit 100 may be disposed parallel to the surface of the device. Accordingly, the camera module including the lens unit 100 may have a low height in the direction perpendicular to the surface of the device, thereby allowing a thinner thickness inside the device, and as a result, the thickness of the device itself may also be reduced.

A first driving member 500 may be connected to the first light path control member 510. The first driving member 500 may include at least one actuator. For example, the first driving member 500 may include at least one of a voice coil motor (VCM), a piezoelectric device, a shape memory alloy, or a MEMS device as the actuator. The first driving member 500 may move the first light path control member 510 using the driving force of the actuator. For example, the first driving member 500 may tilt-control the first light path control member 510 about a first axis or a second axis. Specifically, the first driving member 500 may tilt-control the first light path control member 510 about a second direction (Z-axis direction) as a rotation axis. In addition, the first driving member 500 may tilt-control the first light path control member 510 about a third direction (X-axis direction) as a rotation axis. Accordingly, the camera module may compensate for shaking.

The camera module may include a detection unit (not shown) for detecting shaking of the camera module, and the detection unit may detect rotation or position changes applied to the camera module. The detection unit may include at least one of a sensor for detecting a change in angular velocity, for example, a gyro sensor, and a sensor for detecting a change in acceleration, such as an acceleration sensor.

The optical system 1000 and the camera module may include a filter 400. The filter 400, as an optical filter, may be disposed between the lens unit 100 and the image sensor 300. Specifically, the filter 400 may be disposed between the lens of the lens unit 100 closest to the image sensor 300 and the image sensor 300. The filter 400 may include at least one of an infrared filter or a cover glass. The filter 400 may transmit light of a predetermined wavelength band and filter light of a different wavelength band. When the filter 400 includes an infrared filter, it may block radiant heat emitted from external light from being transmitted to the image sensor 300. In addition, the filter 400 may transmit visible light and reflect infrared light.

The optical system 1000 and the camera module may control the movement of the first light path control member 510 according to a control signal. Specifically, when shaking occurs in the camera module, information regarding shaking such as the degree of rotation or position change of sensors may be detected, and correction for the shaking may be performed. Accordingly, the camera module 1000 according to an embodiment may effectively compensate for shaking due to rotation and shaking due to position change when photographing an object located at infinity to a close distance. Therefore, the camera module 1000 may have improved optical characteristics.

Referring to FIG. 2, the optical system 1000 and camera module according to an embodiment may include a lens unit 100, an image sensor 300, a first light path control member 510, and a second light path control member 520. The first light path control member 510 may be disposed along the optical path of light reflected from a subject, and the lens unit 100 may be disposed between the first light path control member 510 and the image sensor 300. The first light path control member 510 may change the path of light incident in a first direction (Y-axis direction) to a second direction (Z-axis direction) along which the plurality of lenses of the lens unit 100 are arranged.

The second light path control member 520 may be disposed between the lens unit 100 and the image sensor 300. The second light path control member 520 may change the path of light passing through the lens unit 100. The second light path control member 520 may include a reflector or a prism. For example, the second light path control member 520 may include a right-angle prism. When the second light path control member 520 includes a right-angle prism, it can reflect the path of light passing through the lens unit 100 at a 90-degree angle. The second light path control member 520 can change the path of light passing through the lens unit 100 in the second direction (Z-axis direction) to the first direction (Y-axis direction) toward which the image sensor 300 is arranged. The optical axis of the lens unit 100 may be parallel to the upper surface of the image sensor 300. In other words, light reflected from the subject may sequentially pass through the first light path control member 510, the lens unit 100, and the second light path control member 520 to reach the image sensor 300.

The second light path control member 520 may have a predetermined height. Specifically, the height of the second light path control member 520 in the first direction (Y-axis direction) may be smaller than the height of the first light path control member 510 in the first direction. Additionally, the height of the second light path control member 520 in the second direction (Z-axis direction) may be smaller than its height in the first direction. Accordingly, the first direction height of the camera module can be prevented from increasing due to the second light path control member 520 and the image sensor 300, allowing the camera module to be provided in a slimmer and more compact form. Furthermore, since the upper surface of the image sensor 300 is arranged parallel to the optical axis of the lens unit 100, a larger-sized image sensor 300 can be applied, enabling high-resolution imaging results.

The first light path control member 510 is connected to a first driving member (not shown) and may be tilted about at least one of a second direction (Z-axis direction) and a third direction (X-axis direction) as a rotation axis. Accordingly, the camera module may compensate for shaking caused by rotation. The image sensor 300 is connected to a second driving member (not shown), and the position of the image sensor 300 may be controlled. For example, the second driving member may move the image sensor 300 in at least one of the second direction (Z-axis direction) and the third direction (X-axis direction). By the driving force of the second driving member, the image sensor 300 may compensate for positional changes caused by shaking of the camera module. Accordingly, the first light path control member 510 may be tilted about a first axis or a second axis by an applied control signal and may compensate for shaking due to rotation. Specifically, the first light path control member 510 may be tilted with the second direction (Z-axis direction) or the third direction (X-axis direction) as a rotation axis. In addition, the image sensor 300 may move in at least one of the second direction (Z-axis direction) and the third direction (X-axis direction) by an applied control signal, and may compensate for shaking caused by positional changes. The camera module according to the embodiment may set the tilt angle of the first light path control member 510 and the position of the image sensor 300 based on angular velocity and acceleration variation amounts detected through sensors (e.g., Hall sensors). In this case, the tilt angle of the first light path control member 510 may be set through rotation caused by shaking, and the moving distance of the image sensor 300 may be set through positional change caused by shaking. Accordingly, by using the optical system and the camera module according to the embodiment, shaking caused by rotation and positional change may be effectively compensated during photographing of an object located from infinity to close distance.

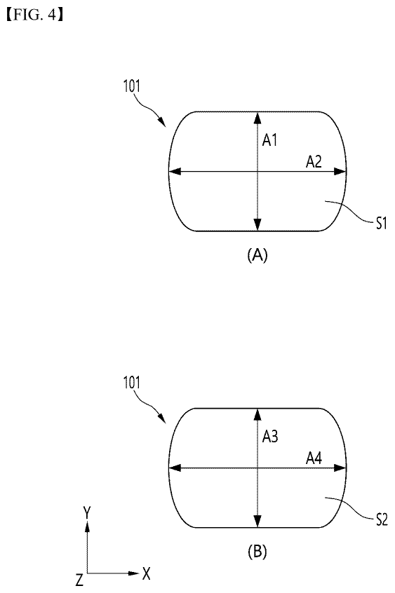

Referring to FIGS. 3 and 7, the lens part 100 of the optical system 1000 according to an embodiment of the present invention may include a plurality of lens groups LG1 and LG2. Each of the plurality of lens groups LG1 and LG2 includes at least one lens. The optical system 1000 may include a first lens group LG1 and a second lens group LG2 sequentially arranged along an optical axis OA from an object toward the image sensor 300. The number of lenses of each of the first lens group LG1 and the second lens group LG2 may be different from each other. The number of lenses of the first lens group LG1 may be greater than the number of lenses of the second lens group LG2, and for example, may be at least twice the number of lenses of the second lens group LG2.

The optical system 1000 may include n lenses, wherein an n-th lens is closest to the image sensor 300, and an (n−1)th lens may be closest to the n-th lens. The n is an integer of 5 or less, for example, 3 to 5. The first lens group LG1 may include at least two lenses. The first lens group LG1 may have three or fewer lenses, for example, three lenses. The second lens group LG2 may include one or more lenses, for example, one or two lenses, and preferably one lens. The first lens group LG1 may include at least one glass lens and at least one plastic lens. The first lens group LG1 may provide a first lens 101 closest to an object as a glass lens. When the first lens 101 is provided with glass material, the camera module 1000 may maintain constant optical performance even when the temperature changes from low to high. In addition, when a spherical surface is applied to the glass lens, a large difference between the center thickness and edge thickness of the first lens 101 may be provided, thereby improving assemblability with a lens barrel. In the first lens group LG1, the number of glass lenses may be less than the number of plastic lenses. The second lens group LG2 may include a plastic lens. Such a plastic lens may allow adjustment of thickness or curvature radius to control the refractive power of incident light of each lens.

The lenses of the first lens group LG1 may include spherical lenses and aspherical lenses. In another example, the lenses of the second lens group LG2 may include aspherical lenses. Since the optical system 1000 mixes spherical and aspherical lenses, thermal compensation and suppression of various aberrations may be achieved. The spherical lens is a lens whose object-side surface and sensor-side surface are spherical on the optical axis. The aspherical lens is a lens whose object-side surface and/or sensor-side surface has an aspherical shape. Here, since the first lens 101 closest to the object is provided as a spherical lens, the center thickness of the first lens 101 may be provided to be thicker than the center thickness of the aspherical lenses, thermal compensation may be facilitated, and assemblability may be improved. The aspherical lenses may reduce chromatic dispersion for TTL and reduce image distortion at the periphery. TTL (Total track length) is the optical axis distance from the center of the object-side surface of the first lens 101 to the surface of the image sensor 300.

The maximum Abbe number of the lenses of the optical system 1000 is 45 or more, and a lens having the maximum refractive index may be 1.60 or more. By the lens having the maximum Abbe number, chromatic dispersion may be reduced, and the maximum optical axis distance of the lenses may be reduced. In addition, the lens having the maximum refractive index may increase chromatic dispersion of incident light, thereby enabling adjustment of the interval between the image sensor 300 and the last lens. The refractive index of an i-th lens is Ndi, the Abbe number of the i-th lens is Vdi, and the value of Ndi*Vdi may be maximum when i is 1. Further, when the value of Ndi*Vdi is 55 or more, i=1, and when the value of Ndi*Vdi is less than 50, i may be 2, 3, or 4. A lens having the minimum effective diameter in the optical system 1000 may satisfy a condition of 30< (Ndi*Vdi)<50, wherein * denotes multiplication. In the following description, the effective diameter may be the maximum diameter or maximum effective length passing through the center of each lens surface, or the effective diameter of a virtual circle.

A lens having the maximum effective length in the lens part 100 may be a spherical lens, and a lens having the minimum effective length may be an aspherical lens. The effective length of each lens may be the maximum length of a non-effective region through which effective light incident on each lens passes, and is an average of the effective length of the object-side surface and the effective length of the sensor-side surface. In the embodiment, the object-side surface of the first lens 101 in the optical system 1000 has a convex shape on the optical axis, and the sensor-side surface of an n-th lens may have a convex shape on the optical axis. Accordingly, the first lens 101 may increase an amount of incident light and refract the incident light to the periphery of the image sensor 300. In addition, since the object-side surface and the sensor-side surface of the n-th lens are provided without a critical point, the TTL may be reduced. Each of the lenses may include an effective region and a non-effective region. The effective region may be a region through which incident light passes in each of the lenses. That is, the effective region may be defined as an effective region in which incident light is refracted to realize optical characteristics. The non-effective region may be disposed around the effective region and may be defined as a flange portion. The non-effective region may be a region in which effective light does not enter among the plurality of lenses. That is, the non-effective region may be a region irrelevant to the optical characteristics. In addition, an end portion of the non-effective region may be a region fixed to a lens barrel (not shown) accommodating the lens.

In the optical system 1000, the TTL (Total top length) may be greater than twice ImgH, for example, greater than twice and less than six times. Preferably, the condition 2<TTL/ImgH<6 may be satisfied. The ImgH is a length from the center of the image sensor 300 to a diagonal end or one-half of a diagonal length of the image sensor 300. In the optical system 1000, the effective focal length (EFL) is greater than 7 mm, and the field of view (FOV) in the diagonal direction is less than 40 degrees, for example, 30 degrees or less, so that the optical system may be provided as a telephoto optical system. That is, for a telephoto optical system, the focal length is greater than 7 mm and the field of view is 30 degrees or less, so that the optical system may be provided as a telephoto-type folded optical system.

The length of the image sensor 300 is a maximum length in a diagonal direction perpendicular to the optical axis OA. In the optical system 1000, the number of lenses having an effective length greater than a diagonal length of the image sensor 300 may be one or less, for example, less than one. Preferably, ImgH, which is half of the diagonal length of the image sensor 300, may be less than the effective length of the object-side surface of an (n−1)th lens. At least one of the effective length of the object-side surface and the effective length of the sensor-side surface of the n-th lens may be smaller than the value of ImgH. In addition, the effective length of the first lens 101 closest to the object is an average of maximum effective lengths of the object-side surface and the sensor-side surface, and may be greater than the value of ImgH and less than a value of ImgH*2.

An aperture stop ST may control an amount of light incident on the optical system 1000. The aperture stop ST may be disposed between any two lenses in the lens part 100. A lens adjacent to the object side and the sensor side of the aperture stop ST has an effective length smaller than the effective length of the first lens 101, and the effective length of the lens located on the object side of the aperture stop ST may be greater than the effective length of the lens located on the sensor side of the aperture stop ST. In this way, by adjusting the effective lengths of two adjacent lenses, the aperture stop ST may provide a slim optical system. Here, the effective length is the maximum effective length of each lens surface, and may be an effective length in a major axis or Y-axis direction.

At least one of center thicknesses of (n−1)th and (n−2)th lenses may be thinner than the center thickness of a lens located on the object side of the aperture stop ST, thereby reducing the TTL. In addition, the first lens 101 of the optical system may have a center thickness thicker than the center thickness of a last lens and a larger Sag value of an object-side surface. Accordingly, an amount of light incident through the first lens 101 may be increased, deterioration of optical characteristics due to resolution may be compensated within the optical system, thermal compensation may be achieved, and vignetting characteristics of the optical system 1000 may be improved. Here, the Sag value is a distance from a straight line perpendicular to the optical axis at the center of the object-side surface or sensor-side surface of each lens to a lens surface in the optical axis direction.

In the lens surfaces arranged between the object and the aperture stop ST, the effective length of the lens surfaces tends to decrease toward the aperture stop ST from the object side. In the lens surfaces arranged between the aperture stop ST and the image sensor 300, the effective length of the lens surfaces tends to increase from the aperture stop ST toward the sensor side. Here, the meaning of having a decreasing tendency may include that the effective length of the lens surfaces gradually decreases toward the image sensor 300, or that at least one lens surface has an effective length greater than that of the object-side lens surface.

The aperture stop ST may be disposed between two lenses adjacent to the object (i.e., subject). The aperture stop ST may be disposed between lenses within the first lens group LG1. The aperture stop ST may be disposed between a spherical lens and an aspherical lens. Alternatively, at least one lens selected from the plurality of lenses may serve as an aperture. Specifically, the object-side surface or sensor-side surface of one lens selected among the lenses of the optical system 1000 may serve as an aperture stop that controls light quantity.

The optical axis distance CG3 between the first lens group LG1 and the second lens group LG2 may be the optical axis distance between the sensor-side surface of the first lens group LG1 and the object-side surface of the second lens group LG2. The optical axis distance CG3 between the first lens group LG1 and the second lens group LG2 may be greater than the optical axis distances between adjacent lenses. That is, the optical axis distance CG3 between the first lens group LG1 and the second lens group LG2 may be the maximum among the optical axis distances between adjacent lenses. The optical axis distance CG3 between the first lens group LG1 and the second lens group LG2 may be smaller than the optical axis distance TLG1 of the first lens group LG1 and smaller than the optical axis distance TLG2 of the second lens group LG2. The optical axis distance TLG1 of the first lens group LG1 is the optical axis distance from the object-side surface of the first lens 101 to the sensor-side surface of the third lens 103. The optical axis distance TLG2 of the second lens group LG2 is the optical axis distance between the object-side surface and sensor-side surface of the last lens, that is, the center thickness of the fourth lens 104. Here, the sensor-side surface of the first lens group LG1 may be concave in the optical axis, and the object-side surface of the second lens group LG2 may be concave in the optical axis. In this context, the object-side surface in each of the first and second lens groups LG1 and LG2 may be the object-side surface of the lens closest to the object, and the sensor-side surface may be the sensor-side surface of the lens adjacent to the image sensor 300. The two lens surfaces of the first and second lens groups LG1 and LG2 facing each other may have concave shapes.

The first lens group LG1 has positive power, and the second lens group LG2 may have positive power. The lens closest to the object-side in the first lens group LG1 has positive power, and the lens of the second lens group LG2 may have positive power. When the absolute value of the focal length of the first lens group LG1 is defined as FLG1, and the absolute value of the focal length of the second lens group LG2 is defined as FLG2, the condition FLG1<FLG2 may be satisfied. Here, in the optical system 1000, when the combined focal length of the first lens 101 and the second lens 102 is defined as F12, and the combined focal length of the third lens 103 and the fourth lens 104 is defined as F34, the condition F12<F34 may be satisfied. In addition, when the combined focal length of the second lens 102 and the third lens 103 is defined as F23, the condition F12>F23 may be satisfied. The combined focal length of the first to third lenses 101, 102, and 103 is F13, which is FLG1, and the condition F13>0 may be satisfied. Also, the conditions F12<FLG1<FLG2 and F34<FLG2 may be satisfied. Here, FLG2 is the focal length of the fourth lens 104, which may be defined as F4. The combined focal length of the first to fourth lenses 101, 102, 103, and 104 is F14, which is the focal length F of the optical system, and may have a positive value, and the condition FLG1<F<FLG2 may be satisfied. Furthermore, the number of lenses having negative power in the optical system 1000 may be the same as the number of lenses having positive power.

The first lens group LG1 refracts light incident through the object-side toward the optical axis direction, and the second lens group LG2 may refract light emitted through the first lens group LG1 toward the periphery of the image sensor 300. The optical axis distance CG3 between the first lens group LG1 and the second lens group LG2 may be greater than the maximum center thickness of the lenses within the lens part 100, and may be 0.5 mm or more. In one embodiment, the sum of refractive indices of the lenses of the lens part 100 is 9 or less, for example, in the range of 5 to 9, and the average refractive index may be in the range of 1.58 to 1.68. The sum of Abbe numbers of the lenses is 180 or less, for example, in the range of 120 to 180, and the average of the Abbe numbers may be 50 or less, for example, in the range of 30 to 50. The sum of the center thicknesses of the entire lenses is 6 mm or less, for example, in the range of 3 mm to 6 mm or 4 mm to 6 mm. The average of the center thicknesses of the entire lenses may be 1.5 mm or less, for example, in the range of 0.8 mm to 1.5 mm. The sum of the center distances between the lenses on the optical axis OA is 2.6 mm or less, for example, in the range of 0.8 mm to 2.6 mm or 0.8 mm to 1.5 mm, and may be smaller than the sum of the center thicknesses of the lenses. In addition, the average value of the effective lengths of the respective lens surfaces of the lens part 100 may be 4 mm or more, for example, in the range of 4 mm to 5 mm or 4.2 mm to 4.8 mm. The difference between the maximum and minimum effective lengths of different lenses may be 2.5 mm or less. Accordingly, an optical system in which the effective length difference between lenses is not large may be provided, and the assemblability of the lenses assembled in a lens barrel may be improved.

The F-number (FNo) of the optical system or camera module according to an embodiment of the invention may be 2.0 or greater, for example, in a range of 2.0 to 3.5 or greater than 2.4 and less than 3.0. In the optical system according to an embodiment of the invention, the maximum field of view (diagonal) may be less than 40 degrees, for example, greater than 8 degrees and less than 30 degrees, or in a range of 17 to 27 degrees, thereby providing a telephoto optical system or a fixed-zoom optical system.

The optical system may include at least one of the light path control members 510, 520 shown in FIGS. 1 and 2. The light path control members 510, 520 may reflect externally incident light to change the light path. The optical system may be applied to a folded camera that can reduce the thickness of the camera. By including the light path control member, the optical system may change light incident perpendicular to the surface of the device to be parallel to the surface of the device. Accordingly, the optical system including a plurality of lenses may have a thinner profile within the device, and the device may be provided thinner.

Referring to FIGS. 3 to 7, the optical system 1000 according to an embodiment may include a first lens 101 to a fourth lens 104. The first to fourth lenses 101, 102, 103, 104 may be sequentially aligned along the optical axis OA. Light corresponding to information from the object may pass through the first to fourth lenses 101-104 and an optical filter 400 to reach the image sensor 300. The first to third lenses 101, 102, 103 belong to the first lens group LG1 and are the lenses closest to the object side. The fourth lens 104 may belong to the second lens group LG2 and may be the lens closest to the image sensor 300 within the second lens group LG2 or the lens unit 100. The optical system 1000 may be a fixed-focal-length optical system. Alternatively, the optical system 1000 may be coupled to a lens barrel having a driving mechanism around its circumference. The driving mechanism may move the first lens group LG1 along the optical axis, move the second lens group LG2 along the optical axis, or move both the first and second lens groups LG1 and LG2 along the optical axis.

The first lens 101 may have positive (+) or negative (−) power on the optical axis OA; for example, it may have positive (+) power. The first lens 101 may include a plastic or glass material, for example, it may be made of glass. On the optical axis OA, the object-side first surface S1 of the first lens 101 may be convex, and the sensor-side second surface S2 may be concave. The first lens 101 may have a meniscus shape convex toward the object side along the optical axis. Alternatively, the first surface S1 may be concave and the second surface S2 convex. Both the first and second surfaces S1 and S2 may be spherical along the optical axis. Since the first lens 101 is a glass spherical lens, thermal compensation is possible, preventing deterioration of optical performance. In addition, the first lens 101 may have a center thickness greater than the edge thickness, making it insensitive to assembly tolerance and improving assembly reliability. Because the first surface S1 is convex and the second surface S2 is concave, incident light can be bent toward the optical axis, and the effective length of the second lens 102 can be set smaller than that of the first lens 101. The curvature radius difference between surfaces S1 and S2 of the first lens 101 may be three times or more, and the effective length may be longer than other lenses.

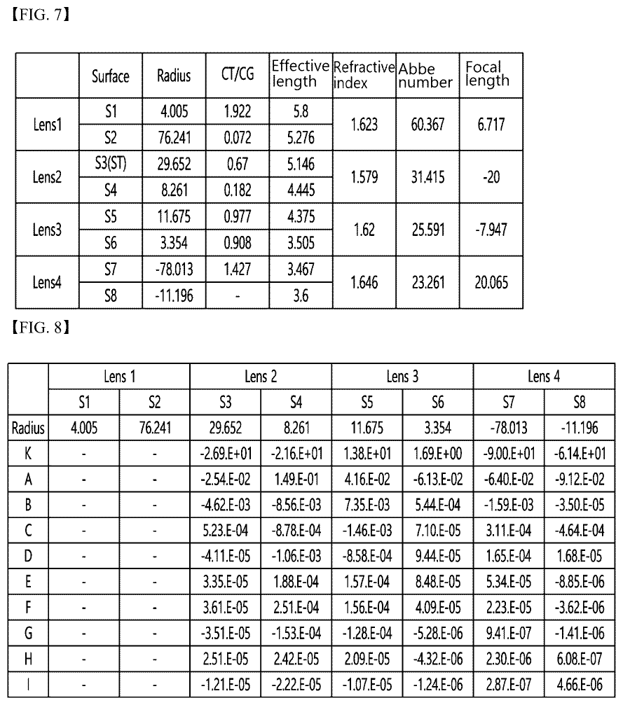

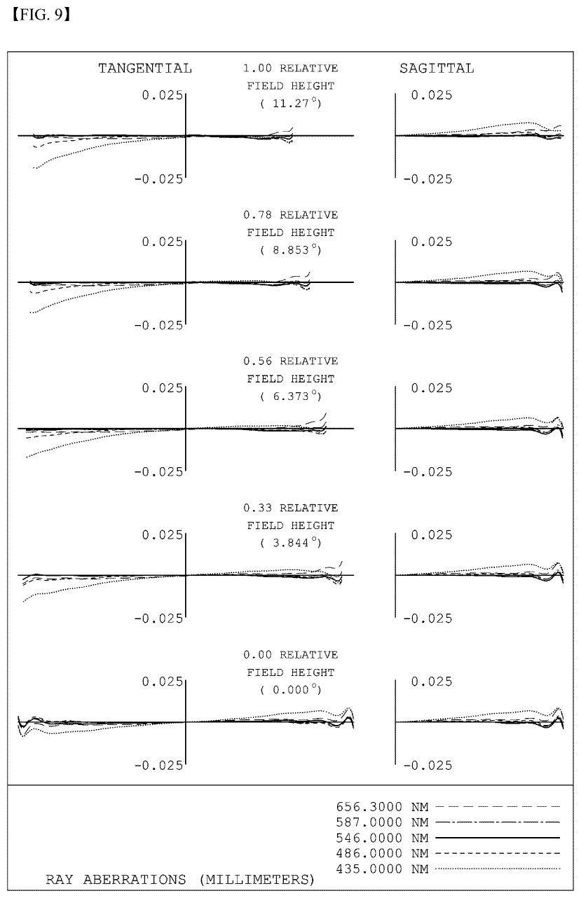

The second lens 102 may be disposed between the first lens 101 and the third lens 103. The second lens 102 may have positive (+) or negative (−) power on the optical axis OA; for example, it may have negative (−) power. The second lens 102 may include plastic or glass material, for example, it may be provided as plastic. On the optical axis OA, the object-side third surface S3 of the second lens 102 may be convex, and the sensor-side fourth surface S4 may be concave. The second lens 102 may have a meniscus shape convex toward the object side along the optical axis. Alternatively, S3 may be convex and S4 convex, or the second lens 102 may be concave on both sides. The second lens 102 may be provided as an aspheric plastic lens. The third and fourth surfaces S3 and S4 may be aspheric. FIG. 8 shows conic constants (K) and aspheric coefficients from 4th to 20th order for surfaces S3 and S4.

The third lens 103 may have positive (+) or negative (−) power on the optical axis OA, for example, negative (−) power. The third lens 103 may include plastic or glass material, for example, plastic. The absolute value of the focal length of the third lens 103 may be smaller than that of the second lens 102 and smaller than the absolute value of the fourth lens 104. Accordingly, the third lens 103 can correct distortion and aberration of the incident light. On the optical axis, the object-side fifth surface S5 of the third lens 103 may be convex, and the sensor-side sixth surface S6 may be concave. The third lens 103 may have a meniscus shape convex toward the object side. Alternatively, the third lens 103 may have a convex meniscus toward the sensor side or be convex or concave on both sides along the optical axis. Surfaces S5 and S6 may be aspheric, with conic constants (K) and aspheric coefficients from 4th to 20th order shown in FIG. 8.

The first to third lenses 101, 102, and 103 may have meniscus shapes convex toward the object side. The effective lengths of surfaces S1-S6 of the first to third lenses 101, 102, and 103 may gradually decrease from the object side toward the image sensor 300. Here, the effective length refers to the maximum length in the X-direction.

The aperture stop ST may be arranged around the first lens 101 and the second lens 102. The aperture stop ST may be disposed around the object-side surface of the second lens 102. The aperture stop ST may be positioned closer to the sensor-side surface of the first lens 101 than to the third lens 103. By placing the aperture stop ST around the first and second lenses 101 and 102, the difference in effective length between the second and third lenses 102 and 103 can be reduced. The first and second lenses 101 and 102 on both sides of the aperture stop ST may have different powers. The effective lengths of the first and second lenses 101 and 102 arranged on the object and sensor sides of the aperture stop ST may be greater than those of the third and fourth lenses 103 and 104. Here, the effective length of each lens is the average of the effective lengths of the object-side and sensor-side surfaces. The curvature radius of the sensor-side second surface S2 of the first lens 101 adjacent to the aperture stop ST and the object-side third surface S3 of the second lens 102 may be 10 mm or more, or 20 mm or more, allowing light incident through a spherical lens to be delivered to an aspheric lens, which can correct distortion and aberration.

The fourth lens 104 may have positive (+) or negative (−) power on the optical axis OA; for example, it may have positive (+) power. The fourth lens 104 may include plastic or glass material, for example, plastic. The absolute value of the focal length of the fourth lens 104 may be larger than those of the first and third lenses 101 and 103, helping correct distortion and aberration. In addition, the focal lengths of the third and fourth lenses 103 and 104 may have opposite signs to correct aberrations. On the optical axis, the object-side seventh surface S7 of the fourth lens 104 may be concave, and the sensor-side eighth surface S8 may be convex. The fourth lens 104 may have a meniscus shape convex toward the sensor side. At least one or both of surfaces S7 and S8 may be aspheric; FIG. 8 shows conic constants (K) and aspheric coefficients from 4th to 20th order for these surfaces. Alternatively, the fourth lens 104 may be convex on both sides or have a meniscus shape convex toward the object side. In another example, the fourth lens 104 may be provided as an aspheric glass lens. The fourth lens 104, being the n-th lens, may have the smallest effective length among the lenses. The center thickness of the fourth lens 104 may be smaller than that of the first lens 101 but larger than those of the second and third lenses 102 and 103.

The difference between the absolute values of the curvature radius of the object-side and sensor-side surfaces of each lens may be largest for the fourth lens 104. For example, the difference in curvature radius between the object-side and sensor-side surfaces of the fourth lens 104 may be greater than that of each of the first to fourth lenses 101-104. To correct distortion and aberration caused by the third and fourth lenses 103 and 104, the second and third lenses 102 and 103 with negative refractive power and the fourth lens 104 with positive refractive power may be arranged. In addition, reducing the spacing between adjacent lenses can suppress TTL increase. The fourth lens 104 may correct the light passing through the first to third lenses 101, 102 and 103 and bend it toward the entire area of the image sensor 300.

The first to fourth lenses 101-104, from the first surface S1 to the eighth surface S8, may have at least one or all surfaces provided without critical points up to the end of the effective region along the optical axis. That is, since the lens surfaces of each lens are provided without critical points, an image sensor 300 having a small size relative to TTL may be set. The fourth lens 104, as the n-th lens, may have a convex sensor-side surface and may refract incident light toward both the central and peripheral regions of the image sensor 300. The optical axis distance from the center of the sensor-side eighth surface S8 of the fourth lens 104 to the top surface of the image sensor 300 is BFL (Back Focal Length), and the optical axis distance from the center of the object-side first surface S1 of the first lens 101 to the sensor-side eighth surface S8 of the fourth lens 104 is TD, the optical axis distance of the first lens group LG1 is TLG1, the optical axis distance of the second lens group LG2 is TLG2, and SD is the optical axis distance from the aperture stop to the sensor-side surface of the last lens. The optical system 1000 may satisfy at least one of the following conditions.

$$TLG 1 < BFL \qquad Condition 1$$

$$( TLG 1 + TLG 2 ) < BFL \qquad Condition 2$$

$$SD < BFL \qquad Condition 3$$

$$SD < TD \qquad Condition 4$$

The optical system 1000 may provide a long BFL, thereby providing a tele-type optical system with a focal length F exceeding 7 mm.

As the combined focal lengths of the lenses, F12, F13, F14, F24, and F34 may satisfy the following conditions. F12 is the combined focal length of the first and second lenses, F14 is the combined focal length of the first through fourth lenses, F24 is the combined focal length of the second through fourth lenses, F34 is the combined focal length of the third and fourth lenses, F13 is the combined focal length of the first through third lenses, i.e., FLG1, and F4 is the focal length of the fourth lens, i.e., FLG2. The power of each lens is the reciprocal of its focal length. The optical system may satisfy at least one or more of the following conditions.

$$Condition 1 : F 12 , F 13 , F 14 > 0$$

$$Condition 2 : F 23 , F 24 > 0$$

$$Condition 3 : F 34 > 0$$

$$Condition 4 : 1 < F 12 , F 23 , F 34 > 10$$

$$Condition 5 : F 13 * 3 < F 4$$

$$Condition 6 : F 12 * 3 < F 14$$

The first through fourth lenses 101,102,103, and 104 may each have effective regions set for their first through eighth surfaces S1,S2,S3,S4,S5,S6,S7, and S8. At least one or more of the first through fourth lenses 101,102,103, and 104 may have different lengths in the first axis X direction and the second axis Y direction. For example, at least one or more of the first through fourth lenses 101,102,103, and 104 adjacent to the object may have a length in the second axis Y direction smaller than the length in the first axis X direction. The first and second axes X and Y are perpendicular to the optical axis OA, the first axis X is perpendicular to the second axis Y, and the second axis Y corresponds to the thickness direction of the portable terminal. For instance, at least one or all of the first through third lenses 101,102, and 103 may have a length in the second axis Y direction smaller than that in the first axis X direction. The lenses 101,102, and 103 of the first lens group LG1 may have a length in the second axis Y direction smaller than in the first axis X direction. Here, the length of each lens 101,102,103, and 104 refers to its effective length or effective diameter. By reducing the effective length in one direction of the first through third lenses 101,102, and 103, the thickness of the camera module including the optical system 1000 and the height in the thickness direction of the portable terminal may be reduced.

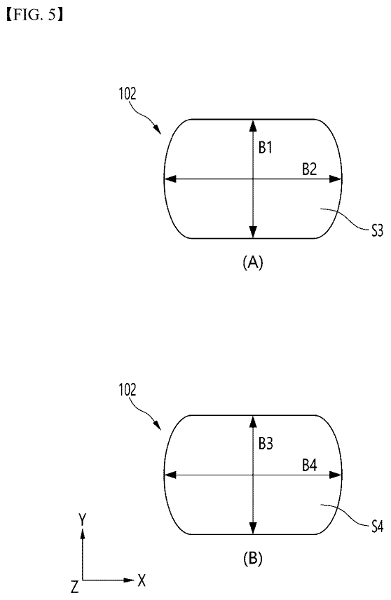

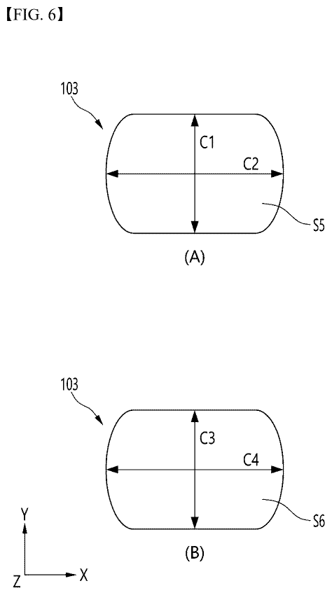

As shown in FIG. 4, the first surface S1 of the first lens 101 may have an effective length A1 in the second axis Y direction passing through the center that is smaller than the effective length A2 in the first axis X direction. The second surface S2 of the first lens 101 may have an effective length A3 in the second axis Y direction passing through the center that is smaller than the effective length A4 in the first axis X direction. Here, the effective length A2 and A4 in the first direction is the maximum length on the first and second surfaces S1 and S2, and the effective length A1 and A3 in the second direction is the minimum length on the first and second surfaces S1 and S2. As shown in FIG. 5, the third surface S3 of the second lens 102 may have an effective length B1 in the second axis Y direction passing through the center that is smaller than the effective length B2 in the first axis X direction. The fourth surface S4 of the second lens 102 may have an effective length B3 in the second axis Y direction passing through the center that is smaller than the effective length B4 in the first axis X direction. Here, the effective length B2 and B4 in the first direction is the maximum length on the third and fourth surfaces S3, S4, and the effective length B1 and B3 in the second direction is the minimum length on the third and fourth surfaces S3 and S4.

As shown in FIG. 6, the fifth surface S5 of the third lens 103 may have an effective length C1 in the second axis Y direction passing through the center that is smaller than the effective length C2 in the first axis X direction. The sixth surface S6 of the third lens 103 may have an effective length C3 in the second axis Y direction passing through the center that is smaller than the effective length C4 in the first axis X direction. Here, the effective length C2 and C4 in the first direction is the maximum length on the fifth and sixth surfaces S5 and S6, and the effective length C1 and C3 in the second direction is the minimum length on the fifth and sixth surfaces S5, S6. As shown in FIG. 4 to FIG. 6, if the maximum effective length of the first surface S1 of the first lens 101 is CA11x and the minimum effective length is CA11y, the following Mathematical Formula: 0.55<CA11y/CA11x<0.98 may be satisfied. Here, CA11x is length A2 and CA11y is length A1. If this value is less than 0.55, it may be difficult to manufacture the object-side surface of the first lens 101 in a non-circular shape and to control the distribution of incident light, and if it exceeds 0.98, the reduction in size in the second direction of the optical system may be insignificant. Similarly, if the maximum effective length of the second surface S2 of the first lens 101 is CA12x and the minimum effective length is CA12y, the following Mathematical Formula: 0.55<CA12y/CA12x<0.98 may be satisfied. Here, CA12x is length A4 and CA12y is length A3. If this value is less than 0.55, it may be difficult to manufacture the sensor-side surface of the first lens 101 in a non-circular shape and to control the distribution of incident light, and if it exceeds 0.98, the reduction in size in the second direction of the optical system may be insignificant.

When each object-side surface S1, S3, and S5 of the first, second, and third lenses 101, 102, and 103 have a maximum effective length Cai1x and a minimum effective length Cai1y, the following Mathematical Formula: 0.55<Cai1y/Cai1x<0.98 may be satisfied. Here, i in Cai1x and Cai1y is 1, 2, or 3. When each sensor-side surface S2, S4, and S6 of the first, second, and third lenses 101, 102, and 103 have a maximum effective length CAi2x and a minimum effective length CAi2y, the following Mathematical Formula: 0.55<CAi2y/CAi2x<0.98 may be satisfied. Here, i in CAi2x and CAi2y is 1, 2, or 3. Accordingly, the thickness of a portable device may not increase even in a high-resolution camera module.

If at least one of the first, second, and third lenses 101, 102, and 103 has a length of the object-side surface and the sensor-side surface that are different in the first and second directions, it might be a D-cut shape lens. That is, both ends in the first direction of each lens surface may be curved, and both ends in the second direction may be flat cut surfaces. The curved ends of the lens surface may form a virtual effective diameter, and the flat cut surfaces may be parallel to each other.

At least one or all of the first lens 101, the second lens 102, and the third lens 103 may have an object-side surface and/or a sensor-side surface with a non-circular shape. When each of the first to third lenses 101, 102, and 103 is viewed from the front corresponding to the optical axis OA, the non-effective region of each lens may have a non-circular shape. The first to third lenses 101, 102, and 103 may have the above-described non-circular shape during the manufacturing process. For example, when the first to third lenses 101, 102, and 103 include a plastic material, they may be manufactured with the above-described non-circular shape through an injection process. Alternatively, the first to third lenses 101, 102, and 103 may be manufactured in a circular shape via the injection process and subsequently formed with side portions in which some areas are cut during a cutting process. Accordingly, the non-effective region of each of the first to third lenses 101, 102, and 103 may have a predetermined size. Here, the length in the first direction X may correspond to the effective length of each of the first to third lenses 101, 102, and 103, and the length in the second direction Y may correspond to the effective length of each of the first to third lenses 101, 102, and 103.

When the first, second, and third lenses 101, 102, and 103 are cut into a non-circular shape, the non-effective region of the first surface S1 of the first lens 101 may be larger than the non-effective regions of surfaces S2 to S6. The maximum effective lengths in the first direction of the first to fourth lenses 101, 102, 103, and 104 for surfaces S1 to S8 may be defined as CA11, CA12, CA21, CA22, CA31, CA32, CA41, and CA42, and the average of the maximum effective lengths of the object-side surface and sensor-side surface may be defined as CA1, CA2, CA3, and CA4. The optical system may satisfy at least one of the following conditions.

$$Condition 1 : CA 3 < CA 2 < CA 1$$

$$Condition 2 : CA 4 < CA 3$$

$$Condition 3 : CA 32 < CA 22 < CA 12 < CA 11$$

$$Condition 4 : CA 31 < CA 41 < CA 32 < CA 42$$

The fourth lens 104 may have equal effective lengths in the first and second axes X and Y. For example, the seventh surface S7 of the fourth lens 104 may have equal effective lengths in the first and second axes X and Y, and the eighth surface S8 may also have equal effective lengths in the first and second axes X and Y. In this way, by arranging the effective lengths of each lens surface of the fourth lens 104 to be equal in the first and second directions, the assembly reliability of the fourth lens 104 within the lens barrel may be prevented from decreasing. In addition, although the above description has explained that at least one of the first to third lenses 101, 102, and 103 may have a non-circular shape, each lens may have a circular non-effective region, and the non-effective region may have a non-circular shape without being limited thereto.

FIG. 7 is an example of lens data for the optical system of the embodiment of FIG. 3. As shown in FIG. 7, the radius of curvature along the optical axis OA, the center thickness CT of each lens, the center distance CG between adjacent lenses, the refractive index at the d-line, the Abbe number, and the effective length (i.e., maximum effective length) of the first to fourth lenses 101, 102, 103, and 104 may be set. In terms of absolute values, the difference in the radius of curvature between the first and second surfaces S1 and S2 of the first lens 101 may be greater than the difference in the radius of curvature between the third and fourth surfaces S3 and S4 of the second lens 102. The difference in the radius of curvature between the fifth and sixth surfaces S5 and S6 of the third lens 103 may be 25 mm or less, or 20 mm or less. The difference in the radius of curvature (absolute value) between the seventh and eighth surfaces S7 and S8 of the fourth lens 104 may be smaller than the difference in the radius of curvature between the object-side surface and the sensor-side surface of the first lens 101. The fourth lens 104 may have an absolute radius of curvature of the object-side surface greater than that of the sensor-side surface, thereby allowing the optical axis distance between the last lens 105 and the image sensor 300 to be extended.

The radius of curvature of the first and second surfaces S1 and S2 of the first lens 101 may be defined as L1R1 and L1R2, respectively, and the radius of curvature of each lens surface of the second, third, and fourth lenses 102, 103, and 104 may be defined as L2R1, L2R2, L3R1, L3R2, L4R1, and L4R2, respectively. The ratios of the radius of curvature between the object-side surface and the sensor-side surface of each lens are as follows. Here, L4R1<0.

$$Condition 1 : 0 < L 1 R 1 / L 1 R 2 < 1$$

$$Condition 2 : 1 < L 2 R 1 / L 2 R 2 < 5$$

$$Condition 3 : 1 < L 3 R 1 / L 3 R 2 < 5$$

$$Condition 4 : 3 < \vert L 4 R 1 / L 4 R 2 \vert < 10$$

$$Condition 5 : 20 mm < \vert L 4 R 1 \vert - L 4 R 2 < 75 mm$$

$$Condition 6 : 20 mm < L 1 R 2 - L 1 R 1 < 75 mm$$

Preferably, the absolute values of L3R2 and L4R1 may differ by at least 25 mm. Here, the tolerance of the radius of curvature may be ±0.05 mm.

The center thicknesses of the first to fourth lenses 101-104 may be defined as CT1 to CT4, and the edge thicknesses of the first to fourth lenses 101-104 may be defined as ET1 to ET4. In this case, the sum of the center thicknesses of the first to fourth lenses 101-104 may be defined as ΣCT, and the sum of the edge thicknesses of the first to fourth lenses 101-104 may be defined as ΣET. The ratio of the center thickness to the edge thickness of each lens may satisfy at least one of the following conditions.

$$Condition 1 : 1 < CT 1 / ET 1 < 4$$

$$Condition 2 : 0.2 < CT 2 / ET 2 < 1.2$$

$$Condition 3 : 0.3 < CT 3 / ET 3 < 1.5$$

$$Condition 4 : 0.5 < CT 4 / ET 4 < 1.5$$

$$Condition 5 : 1 < Σ CT / Σ ET < 1.5$$

$$Condition 6 : 0.2 < CT 1 / Σ CT < 0.7$$

$$Condition 7 : 0.1 < CT 4 / Σ CT < 0.6$$

In the above conditions, in the case of CTi/ETi (i=1 to 5), the maximum may occur when i=1, and the minimum may occur when i=2. The difference between the center thickness and the edge thickness of each lens may be set to more than 0.01 mm and less than 1.5 mm. In addition, the ratio of the center thickness to the edge thickness of the first lens 101 may be designed to be the largest to prevent assembly degradation caused by a spherical lens. Furthermore, since the fourth lens 104 may have an object-side surface with a large radius of curvature and may be provided in a circular shape, the assembly with the lens barrel may be improved.

The center distances between the first to fourth lenses 101-104 may be defined as CG1, CG2, and CG3, and the sum of the center distances between the first to fourth lenses 101-104 may be defined as ΣCG. CT_Max may be the maximum among the center thicknesses of each lens, and CG_Max may be the maximum optical axis spacing between adjacent two lenses. The ratio between the center thickness of each lens and the center distance from an adjacent lens may satisfy at least one of the following conditions.

$$Condition 1 : 10 < CT 1 / CG 1 < 50$$

$$Condition 2 : 1 < CT 2 / CG 2 < 10$$

$$Condition 3 : 0.5 < CT 3 / CG 3 < 2$$

$$Condition 4 : 1 < CT 4 / CG 3 < 2$$

$$Condition 5 : ( CT 3 / CG 3 ) < ( CT 2 / CG 2 ) < ( CT 1 / CG 1 )$$

$$Condition 6 : 0.5 < CG 3 / Σ CG < 1$$

$$Condition 7 : 0.2 < CT\_Max / CG\_Max < 0.7$$

Here, if the ith center distance among the center distances between adjacent two lenses is defined as CGi, and the center thickness of the ith lens arranged on the object side of CGi is defined as CTi, the following conditions may be satisfied. The ratio CTi/CGi may be maximum when i=1 and minimum when i=3. The condition for CTi/CGi to be maximum when i=1 may allow the optical axis spacing between the first and second lenses 101, 102 to be minimized, and the first lens 101 may have an object-side surface implemented as a spherical surface.

The focal lengths F1 and F4 of the first and fourth lenses 101 and 104 may have positive refractive power, whereas the focal lengths F2 and F3 of the second and third lenses 102 and 103 may have negative refractive power. When expressed in absolute values, the focal length of the first lens 101 may be the shortest among the lenses and may be 10 mm or less. At least one of the focal lengths of the second and fourth lenses 102, 104 may be the longest among the lenses. The difference between the maximum focal length and the minimum focal length may be 5 mm or more. By the above focal lengths, the optical system may have improved MTF characteristics, aberration control, and resolution characteristics within the set field of view, and may have favorable optical performance even at the peripheral regions of the field of view.

FIG. 9 is a graph illustrating the optical aberration characteristics of the optical system of FIG. 3 according to an embodiment. In the aberration graph of FIG. 9, as an analysis graph showing transverse aberration in the first and second directions (X, Y) in the region where the relative field height on the optical axis is 0.0 to 1.0 in the tangential field curvature and sagittal field curvature of the optical system, it can be confirmed that an optical system having a good state of transverse aberration correction can be obtained for light in wavelength bands of about 435 nm, about 486 nm, about 546 nm, about 587 nm, and about 656 nm. That is, the optical system 1000 according to the embodiment may have improved resolution and exhibit good optical performance not only at the center but also at the periphery of the field of view (FOV). As confirmed in the above embodiment, the lens system of the embodiment according to the present invention is compact and lightweight with a four-lens configuration, and at the same time, spherical aberration, astigmatism, distortion aberration, chromatic aberration, and coma aberration are all well corrected to enable high resolution implementation, so it can be built into the optical device of a camera and utilized.

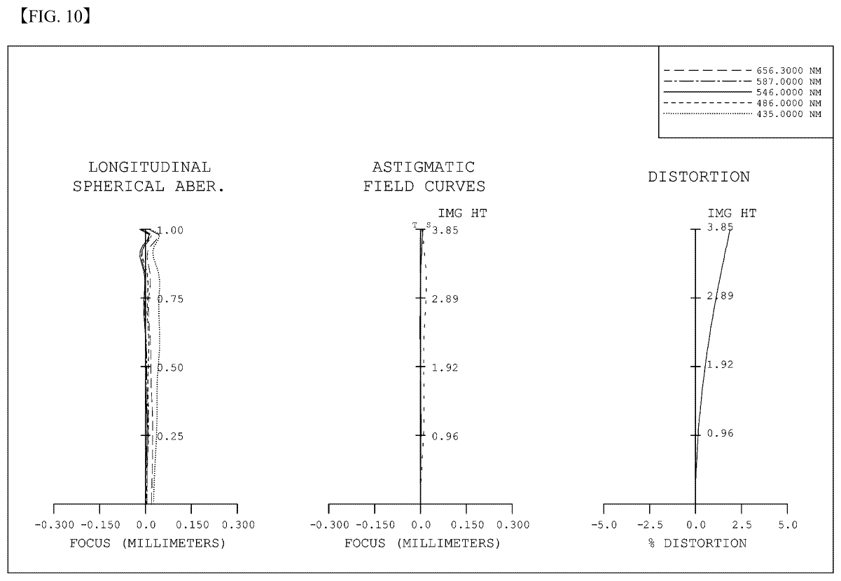

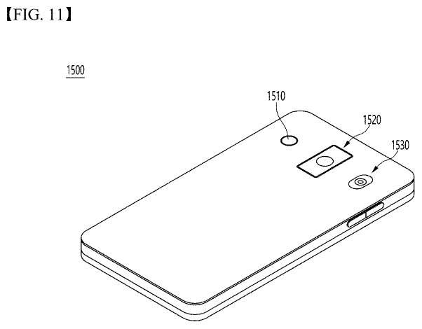

FIG. 10 is a graph illustrating the aberration characteristics of the optical system 1000 of FIG. 3, and in the aberration graph of FIG. 10, the longitudinal spherical aberration, astigmatic field curves, and distortion are measured from the left to the right, and in FIG. 10, the X-axis may represent the focal length (mm) and distortion (%) and the Y-axis may represent the image height. In addition, the graph of the spherical aberration corresponds to light of wavelength bands of approximately 435 nm, 486 nm, 546 nm, 587 nm, and 656 nm, and the graphs of the astigmatic field curves and distortion correspond to light of a wavelength band of approximately 546 nm. In these aberration graphs, the closer each curve is to the Y-axis, the better the aberration correction function can be interpreted, and in the optical system 1000 according to the embodiment, it can be seen that the measured values are adjacent to the Y-axis in almost all areas. That is, the optical system 1000 according to the embodiment may have improved resolution and may exhibit good optical performance not only at the center of the field of view (FOV) but also at the periphery.

The optical system 1000 according to an embodiment of the invention may satisfy at least one of the following equations described below, and accordingly, when the optical system 1000 satisfies at least one of the following equations, it may have improved optical characteristics, and when the optical system 1000 satisfies at least one of the following equations, it may be implemented more compactly, and when the optical system 1000 satisfies at least one of the following equations, it may be applied to a folded camera having a thinner thickness, thereby allowing a device including the camera to be manufactured with a reduced thickness. When the optical system 1000 satisfies at least one of the equations, the optical system 1000 may effectively control aberration characteristics such as chromatic aberration and distortion, and may exhibit good optical performance not only at the center of the FOV but also at the periphery. In addition, the optical system 1000 may have improved resolution, and the thickness of the lenses on the optical axis OA and the spacing between adjacent lenses on the optical axis OA described in the equations may refer to the embodiments disclosed above.

$$L 1 R 1 > 0 \qquad [ Mathematical Formula 1 ]$$

L1R1 is the radius of curvature along the optical axis of the object-side surface of the first lens, and when Mathematical Formula 1 is satisfied, it may increase the amount of incident light. Accordingly, the first lens 101 may have a meniscus shape that is convex toward the object side. In addition, since the condition L1R1*L1R2>0 is satisfied, the incident light may be refracted toward the direction closer to the optical axis. Accordingly, in the embodiment, the maximum effective length of the second lens may be smaller than the maximum effective length of the first lens. The first to third lenses may have meniscus shapes that are convex toward the object side, and they may refract the incident light toward the area between the first and second lens groups LG1 and LG2. Moreover, since the conditions LIR1<LIR2 and L2R2<L2R1 are satisfied, the maximum effective lengths of the first and second lenses may be adjusted, and the TTL may be reduced. If the condition L2R2>L2R1 occurs, the distance between the first and second lenses 101 and 102 may increase, and the optical characteristics at the boundary between the spherical lens and the aspherical lens may degrade. The absolute difference between the radii of curvature of the object-side surface and the sensor-side surface of the fourth lens 104 may be set larger than the absolute differences of the radii of curvature of the object-side and sensor-side surfaces of the second and third lenses, thereby reducing the impact on the optical characteristics of the incident light.

$$L 4 R 2 < 0 \qquad [ Mathematical Formula 2 ]$$

L4R2 is the radius of curvature along the optical axis of the sensor-side surface of the fourth lens 104, and when Mathematical Formula 2 is satisfied, the fourth lens 104 having positive refractive power may refract light toward the peripheral portion of the image sensor 300. Accordingly, distortion and aberration characteristics at the center and periphery of the image sensor 300 may be improved. The fourth lens 104 may be provided in a meniscus shape convex toward the sensor side along the optical axis, so that light may be uniformly refracted to both the center and the periphery of the image sensor 300 through the long BFL region between the fourth lens 104 and the image sensor 300.

$$2 < TLG 1 / TLG 2 < 5 \qquad [ Mathematical Formula 3 ]$$

TLG1 refers to the optical axis distance of the first lens group, preferably the optical axis distance from the center of the object-side surface of the first lens to the center of the sensor-side surface of the third lens. TLG2 refers to the optical axis distance of the second lens group, preferably the optical axis distance from the center of the object-side surface of the fourth lens to the center of its sensor-side surface. When the optical system satisfies Mathematical Formula 3, it may provide a telephoto (Tele) type optical system having a BFL of 5 mm or more.

$$0.50 < CAn 2 / CA 11 < 0.9 \qquad [ Mathematical Formula 4 ]$$

CAn2 is the maximum effective length of the sensor-side surface of the last n-th lens, and CA11 is the maximum effective length of the object-side surface of the first lens. Mathematical Formula 4 may define a condition for the first lens having the largest effective length to be non-circular. For example, it may be cut in a shape in which the effective length in the second direction perpendicular to the optical axis is smaller than the effective length in the first direction. Accordingly, the first lens may have a D-cut shape, which may reduce the thickness of a camera module mounted in the thickness direction of a portable terminal. Here, if the last lens is the fourth lens, it may satisfy 0.50<CA42/CA11<0.9. Preferably, it may satisfy 0.55<CA42/CA11<0.8. If the value is smaller than the range of the Mathematical Formula, the characteristics of RI (Relative illumination) and MTF (Modulation transfer function) may be degraded.

If both ends in the second direction of the object-side surface and the sensor-side surface of the first lens are cut, the condition of Mathematical Formula 4-1:0.55<CA42/CA12<0.9 may be satisfied. If both ends in the second direction of the object-side surface and the sensor-side surface of the second lens are cut, the conditions of Mathematical Formula 4-2:0.55<CA42/CA21<0.9 and 0.55<CA42/CA22<0.9 may be satisfied. If both ends in the second direction of the object-side surface and the sensor-side surface of the third lens are cut, the conditions of Mathematical Formula 4-3:0.55<CA42/CA31<0.9 and 0.55<CA42/CA32<0.9 may be satisfied. Together with Mathematical Formula 4, if the conditions of Mathematical Formula 4-1 through Mathematical Formula 4-3 are satisfied, the height or thickness of the camera module in the second direction may be reduced, and the thickness of a portable terminal having this camera module may not increase. Furthermore, by satisfying at least one of Mathematical Formula 4-1 through Mathematical Formula 4-3, deterioration of the RI (Relative Illumination) and MTF (Modulation Transfer Function) characteristics may be prevented.

$$5 mm < ( C A 41 + C A 42 ) < 9 mm \qquad [ Mathematical Formula 5 ]$$

CA41 is the effective diameter of the object-side surface of the fourth lens, and CA42 is the effective diameter of the sensor-side surface of the fourth lens. The fourth lens is a circular lens to ensure optical performance and assemblability. Mathematical Formula 5 may be used to set the effective diameter of the last lens when at least one of the first to third lenses 101,102,103 is cut at both ends in the thickness direction of a portable terminal. Preferably, it may include 6 mm< (CA41+CA42)<8 mm.

$$1.6 < Nd 4 < 1.7 \qquad [ Mathematical Formula 6 ]$$

Nd4 is the refractive index of the fourth lens 104 at the d-line. By setting a high refractive index for the fourth lens 104 according to Mathematical Formula 6, elements affecting the reduction of third-order aberrations (Seidel aberrations) of the optical system may be controlled, and aberrations that may occur when TTL is somewhat long may be reduced. Preferably, Mathematical Formula 6 may satisfy 1.63≤Nd4<1.7. If designed lower than the lower limit of Mathematical Formula 6, aberrations may be reduced to achieve performance, but the power of the fourth lens 104 may be weakened, which may reduce the performance of the optical system. If the refractive index of the fourth lens 104 is designed lower than the lower limit of Mathematical Formula 6, the curvature radius of the fourth lens 104 must be increased to increase the power of the fourth lens, and securing BFL may be difficult.

$$1.58 < Nd 3 < 1.67 \qquad [ Mathematical Formula 6 - 1 ]$$

$$Nd 3 < Nd 4 \qquad [ Mathematical Formula 6 - 2 ]$$

$$Nd 2 < 1.6 < Nd 1 \qquad [ Mathematical Formula 6 - 3 ]$$

Here, Nd1, Nd2, and Nd3 are the refractive indices at the d-line of the first, second, and third lenses, respectively, and Nd4 is the refractive index at the d-line of the fourth lens. By setting the refractive indices of the third and fourth lenses, chromatic dispersion may be controlled. In addition, Nd2 may be set to be less than 1.60 to suppress chromatic dispersion of the incident light.

$$0 < nL\_CAx \neq nL\_CAy < 4 \qquad [ Mathematical Formula 7 ]$$

In nL_CAx and nL_CAy, nL indicates the lens position adjacent to the object, which is 1, 2, or 3. Mathematical Formula 7 indicates that at least one or all of the first to third lenses may have different effective lengths in the first and second directions. That is, at least one of the first, second, or third lenses may have different averages (CAx, CAy) of the effective lengths in the first and second directions of the object-side surface and sensor-side surface. For example, the average effective length of the object-side surface and sensor-side surface in the second direction may be smaller than the average effective length of the object-side surface and sensor-side surface in the first direction. Accordingly, when Mathematical Formula 7 is satisfied, the thickness of the tele-type optical system and the camera module including the same may be reduced.

$$0.55 < CA 11 y / CA 11 x < 0.98 \qquad [ Mathematical Formula 8 ]$$

Here, CA11x is the effective length in the first direction of the object-side surface of the first lens, and CA11y is the effective length in the second direction of the object-side surface of the first lens. When Mathematical Formula 8 satisfies the above range, the object-side surface of the first lens may be set as a lens cut at both ends in the second direction, which may reduce the thickness of the optical system. In addition, if the range of Mathematical Formula 8 is below the lower limit, the lens cutting ratio may be reduced, making the process more complex.

$$0.55 < CA 12 y / CA 12 x < 0 \text{.98} \qquad [ Mathematical Formula 8 - 1 ]$$

$$0.55 < CA 21 y / CA 21 x < 0.98 \qquad [ Mathematical Formula 8 - 2 ]$$

$$0.55 < CA 22 y / CA 22 x < 0.98 \qquad [ Mathematical Formula 8 - 3 ]$$

$$0.55 < CA 31 y / CA 31 x < 0.98 \qquad [ Mathematical Formula 8 - 4 ]$$

$$0.55 < CA 32 y / CA 32 x < 0.98 \qquad [ Mathematical Formula 8 - 5 ]$$

Here, CA12x and CA12y are the effective lengths in the first and second directions of the sensor-side surface of the first lens; CA21x and CA21y are the effective lengths in the first and second directions of the object-side surface of the second lens; CA22x and CA22y are the effective lengths in the first and second directions of the sensor-side surface of the second lens; CA31x and CA31y are the effective lengths in the first and second directions of the object-side surface of the third lens; and CA32x and CA32y are the effective lengths in the first and second directions of the sensor-side surface of the third lens. When at least one of Mathematical Formulas 8, 8-1 to 8-5 is satisfied, or at least one of the lenses with a large effective diameter is cut, the overall height of the optical system may be reduced, allowing it to be applied to a folded camera module and preventing an increase in the thickness of the portable terminal. In addition, the averages of the effective lengths in the first and second directions of the object-side surface and sensor-side surface of the first and second lenses may be within 88% to 120% of the averages of the effective diameters in the first and second directions of the object-side surface and sensor-side surface of the fourth lens.

$$1 < CT 1 / CT 4 < 3 \qquad [ Mathematical Formula 9 ]$$

CT1 means the center thickness of the first lens 101, and CT4 means the center thickness of the fourth lens 104. Mathematical Formula 9 may set the center thickness difference between the first and fourth lenses, guide the optical path of the optical system easily, and improve the optical performance at the center and periphery of the field of view (FOV). Preferably, it may satisfy 1<CT1/CT4<2. When Mathematical Formula 9 is satisfied, it may improve aberration characteristics, and set the influence on the reduction of the optical system. Accordingly, it may improve chromatic aberration of the optical system, have good optical performance at the set field of view, and control TTL (total track length).

In addition, the center thickness CT3 of the third lens 103 may be thinner than the center thickness CT1 of the first lens 101. The center thickness CT3 of the third lens 103 may be thicker than the center thickness CT2 of the second lens 102.

$$0.1 < CG 3 / CT 123 < 0.5 \qquad [ Mathematical Formula 10 ]$$

CG3 is the center distance between the third and fourth lenses, and CT123 is the sum of the center thicknesses of the first, second, and third lenses. In Mathematical Formula 10, the center distance of the third and fourth lenses may be set to exceed 0.1 times and be less than 0.5 times the sum of the center thicknesses of the first, second, and third lenses, so that light collected by the first lens group may be guided to disperse through the second lens group. The aperture stop may be placed around the area between the first and second lenses.

$$0.3 < CG 3 / CT 4 < 1 \qquad [ Mathematical Formula 11 ]$$

CT4 is the center thickness of the fourth lens 104. In Mathematical Formula 11, the center distance CG3 of the third and fourth lenses may be set smaller than the center thickness of the fourth lens 104, so that the optical axis distance between the second lens group and the image sensor 300 may be secured. Preferably, it may satisfy 0.45<CG3/CT4<0.85.

$$1 < B FL / TLG 1 < 3 \qquad [ Mathematical Formula 12 ]$$

BFL means the optical axis distance from the center of the object-side surface of the last lens to the top surface of the image sensor. That is, BFL is the optical axis distance between the object-side surface of the fourth lens 104 and the image sensor 300. TLG1 is the optical axis distance of the first lens group, that is, the optical axis distance from the center of the object-side surface of the first lens 101 to the center of the sensor-side surface of the third lens 103. When Mathematical Formula 12 is satisfied, the focal length of the folded type tele optical system may be adjusted. Preferably, it may satisfy 1.8<BFL/TLG1<2.6.

$$4 < B F L / T L G 2 < 8 \qquad [ Mathematical Formula 13 ]$$

TLG2 is the optical axis distance of the second lens group, that is, the optical axis distance from the center of the object-side surface of the fourth lens 104 to the center of the sensor-side surface. When Mathematical Formula 13 is satisfied, the focal length of the folded type tele optical system may be adjusted. Preferably, it may satisfy 5<BFL/TLG2<7.5.

$$1 < CA 11 / CA 41 < 3 \qquad [ Mathematical Formula 14 ]$$

CA11 means the effective length of the first surface S1 of the first lens 101, that is, the effective length in the first direction, and CA41 means the effective diameter of the seventh surface S7 of the fourth lens 104. When Mathematical Formula 14 is satisfied, the optical system 1000 may control incident light and may set elements affecting aberrations. Preferably, it may satisfy 1.3<CA11/CA41<2. Since the first and fourth lenses satisfy Mathematical Formula 14, the difference in effective length between the first and fourth lenses is not large, so it may reduce the effects caused by assemblability and reduce the influence on optical characteristics.

$$0 < C A 32 / C A 41 < 2 \qquad [ Mathematical Formula 15 ]$$

CA32 means the effective length of the sixth surface S6 of the third lens 103, that is, the maximum effective length, and CA41 means the effective diameter of the seventh surface S7 of the fourth lens 104. When Mathematical Formula 15 is satisfied, the optical system 1000 may control light progressing from the first lens group LG1 to the second lens group LG2, and may set elements affecting lens sensitivity reduction. Preferably, Mathematical Formula 15 may satisfy 0.5<CA32/CA41<1.5. Mathematical Formula 15 may set the effective lengths of two opposing lens surfaces within the first and second lens groups.

$$0 < C A 41 / C A 42 < 2 \qquad [ Mathematical Formula 16 ]$$

CA41 is the effective diameter of the object-side surface of the fourth lens 104, and CA42 means the effective diameter of the sensor-side surface S8 of the fourth lens 104. When the optical system 1000 according to an embodiment satisfies Mathematical Formula 16, the effective diameter of the lenses in the second lens group may be set. Preferably, it may satisfy 0.5<CA41/CA42<1.5. Since the effective length of the fourth lens satisfies Mathematical Formula 16, a slim folded optical system may be provided.

$$1 < B F L / C A 1 < 5 \qquad [ Mathematical Formula 17 ]$$

CA1 is the average of the maximum effective lengths of the object-side surface and sensor-side surface of the first lens 101. That is, CA1 is the effective length in the long-axis direction of the first lens 101. When Mathematical Formula 17 is satisfied, the optical axis distance BFL between the last lens and the image sensor may be set, and a tele-type folded optical system may be provided. Preferably, it may satisfy 1<BFL/CA1<2.

$$2 < B F L / C A 4 < 5.5 \qquad [ Mathematical Formula 18 ]$$

CA4 is the average of the effective diameters of the object-side surface and sensor-side surface of the fourth lens 104. When Mathematical Formula 18 is satisfied, the optical axis distance BFL between the last lens and the image sensor may be set, and a tele-type folded optical system may be provided. Preferably, it may satisfy 2<BFL/CA4<3.

$$7 < B F L / C G 3 < 12 \qquad [ Mathematical Formula 19 ]$$

When Mathematical Formula 18 is satisfied, the center distance between the first and second lens groups and the optical axis distance BFL between the last lens and the image sensor may be set, and a tele-type folded optical system may be provided.

$$0.1 < TLG 1 / TTL < 0.5 \qquad [ Mathematical Formula 20 ]$$

TTL means the optical axis distance from the object-side surface of the first lens 101 to the upper surface of the image sensor. When the optical system satisfies Mathematical Formula 20, the optical axis distance of the first lens group TLG1 relative to the total length TTL may be set, and the effective diameter, curvature radius, refractive index, and Abbe number of the lenses in the first lens group may be set. Preferably, it may satisfy 0.2<TLG1/TTL<0.3.

$$0 < TLG 2 / TTL < 0.3 \qquad [ Mathematical Formula 21 ]$$

When the optical system satisfies Mathematical Formula 21, the optical axis distance of the second lens group TLG2 relative to the total length TTL may be set, and the effective diameter, curvature radius, refractive index, and Abbe number of the lenses in the second lens group may be set. Preferably, it may satisfy 0<TLG2/TTL<0.15.

$$1 < \vert L 2 R 1 / L 4 R 2 \vert < 3 \qquad [ Mathematical Formula 22 ]$$

L2R1 means the curvature radius of the third surface of the second lens 102, and L4R2 means the curvature radius of the eighth surface of the fourth lens 104. In Mathematical Formula 22, the curvature radii of the object-side surface of the second lens 102 and the sensor-side surface of the fourth lens 104 may be set, and the power of the second and fourth lenses may be controlled. Accordingly, good optical performance may be achieved at the center and periphery of the field of view. Preferably, Mathematical Formula 22 may satisfy 2<|L2R1/L4R2|<3.

$$5 < \vert L 4 R 1 / C T 4 \vert < 12 \qquad [ Mathematical Formula 23 ]$$

L4R1 means the curvature radius of the object-side surface of the fourth lens 104, and CT4 is the center thickness of the fourth lens 104. When Mathematical Formula 23 is satisfied, the power of the fourth lens may be controlled to manage incident light with the aspheric lens, and degradation of the aspheric lens assembly may be prevented. Preferably, it may satisfy 6<|L4R1/CT4|<10.

$$0 < L 3 R 2 / \vert L 4 R 1 \vert < 0.5 \qquad [ Mathematical Formula 24 ]$$

L3R2 means the curvature radius of the sensor-side surface of the third lens 103, and L4R1 means the curvature radius of the object-side surface of the fourth lens 104. When Mathematical Formula 24 is satisfied, the shapes and curvature radii of the lens surfaces facing each other within the first and second lens groups may be adjusted to control light dispersion. Preferably, it may satisfy 0<L3R2/|L4R1|<0.2.

$$3 < \vert L 4 R 1 / L 4 R 2 \vert < 10 \qquad [ Mathematical Formula 25 ]$$

L4R1 means the curvature radius of the object-side surface of the fourth lens 104, and L4R2 means the curvature radius of the sensor-side surface of the fourth lens 104. When Mathematical Formula 25 is satisfied, the curvature radius of the lens located at the center of the optical system may be adjusted to reduce light sensitivity. Preferably, it may satisfy 5<|L4R1/L4R2|<9.

$$1 < L 3 R 1 / L 3 R 2 < 5 \qquad [ Mathematical Formula 26 ]$$

By setting the curvature radius of the object-side surface L3R1 and the curvature radius of the sensor-side surface L3R2 of the third lens 103, and when Mathematical Formula 25-1 is satisfied, the curvature radius of the third lens located at the center of the optical system may be adjusted to reduce light sensitivity.

$$1. 5 < TTL / TD < 3 \qquad [ Mathematical Formula 26 ]$$

TD means the optical axis distance from the object-side surface of the first lens 101 to the sensor-side surface of the last lens. TD is the optical axis distance from the center of the first surface S1 of the first lens 101 to the eighth surface S8 of the fourth lens 104. Preferably, it may be in the range of 2<TTL/TD<3. When the optical system satisfies Mathematical Formula 26, TD relative to TTL may be set to secure a long BFL. Accordingly, a tele-type folded optical system may be provided.

$$1 < TTL / CA\_Max < 5 \qquad [ Mathematical Formula 27 ]$$

CA_Max means the largest effective length among the object-side surfaces and sensor-side surfaces of the plurality of lenses. Mathematical Formula 27 sets the relationship between the total optical axis length of the optical system and the maximum effective length, allowing the tele optical system to be configured. Preferably, Mathematical Formula 27 may satisfy 2<TTL/CA_Max<3.

$$3 < TTL / ImgH < 6 \qquad [ Mathematical Formula 28 ]$$

Mathematical Formula 28 sets the total optical axis length TTL of the optical system and the diagonal length ImgH on the optical axis of the image sensor 300. When the optical system 1000 according to an embodiment satisfies Mathematical Formula 28, the optical system 1000 may have an image sensor smaller in size relative to TTL for application to the image sensor 300, and may provide a tele-type optical system. Preferably, Mathematical Formula 28 may satisfy 3.5<TTL/ImgH<5.5.

$$1 < BFL / ImgH < 5 \qquad [ Mathematical Formula 29 ]$$

Mathematical Formula 29 sets the optical axis distance BFL between the image sensor 300 and the last lens, and the diagonal length ImgH on the optical axis of the image sensor 300. When the optical system 1000 according to an embodiment satisfies Mathematical Formula 29, the optical system 1000 may secure a long BFL relative to the size of the image sensor 300, may set the distance between the last lens and the image sensor 300 for tele-type, and may have good optical characteristics at the center and periphery of the field of view FOV. Preferably, Mathematical Formula 29 may satisfy 2<BFL/ImgH<3, and BFL> (ImgH*2).

$$0.2 < BFL / TTL < 1 \qquad [ Mathematical Formula 30 ]$$

Mathematical Formula 30 sets the total optical axis length TTL of the optical system and the optical axis distance BFL between the image sensor 300 and the last lens. When the optical system 1000 according to an embodiment satisfies Mathematical Formula 30, the optical system 1000 may secure a long BFL. Preferably, Mathematical Formula 30 may satisfy 0.2<BFL/TTL<0.7.

$$0.5 < TTL / F < 1.5 \qquad [ Mathematical Formula 31 ]$$

Mathematical Formula 31 sets the total focal length F and total optical axis length TTL of the optical system 1000, thereby providing a tele-type folded optical system. Preferably, Mathematical Formula 31 may satisfy 0.7<TTL/F<1.2. When the optical system 1000 according to an embodiment satisfies Mathematical Formula 31, the optical system 1000 may have a tele-type focal length within the set TTL range, and may provide an optical system capable of forming an image while maintaining the tele-type focal length. If it is below the lower limit of Mathematical Formula 31, it may be necessary to increase the power of the lenses, making correction of spherical aberration or distortion difficult, and if it exceeds the upper limit of Mathematical Formula 31, the lenses' effective diameter or TTL may increase, causing the imaging lens system to become large.

$$1 < CT\_Max / CG\_Max < 3 \qquad [ Mathematical Formula 32 ]$$

Mathematical Formula 32 sets the maximum center thickness CT_Max among the lenses and the maximum center distance CG_Max between adjacent lenses. When Mathematical Formula 32 is satisfied, the optical system may have good optical performance at the focal length within the set field of view, and TTL may be reduced. Preferably, an embodiment may satisfy 1.5<CT_Max/CG_Max<2.6.

$$2 < \sum CT / \sum CG < 6 \qquad [ Mathematical Formula 33 ]$$

In Mathematical Formula 33, ECT is the sum of the center thicknesses of the lenses, and CG is the sum of the center distances between adjacent lenses. When Mathematical Formula 33 is satisfied, the optical system may have good optical performance at the focal length within the set field of view, and TTL may be reduced. Preferably, an embodiment may satisfy 3<ΣCT/ΣCG<5.5.

$$5 < \sum Nd < 9 \qquad [ Mathematical Formula 34 ]$$

ΣNd is the sum of the refractive indices at the d-line of each of the plurality of lenses. When Mathematical Formula 34 is satisfied, the TTL in the tele-type optical system 1000 may be controlled, and improved resolution may be achieved. Preferably, Mathematical Formula 34 may satisfy 6<ΣNd≤7.

$$10 < \sum Vd / \sum Nd < 50 \qquad [ Mathematical Formula 35 ]$$

ΣVd is the sum of the Abbe numbers of the plurality of lenses. When Mathematical Formula 35 is satisfied, the optical system 1000 may have improved aberration characteristics and resolution. Mathematical Formula 35 sets the sum of the Abbe numbers and the sum of the refractive indices of the lenses, thereby controlling optical characteristics. Preferably, it may satisfy 15<ΣVd/ΣNd<26.

$$0.5 < CA 11 / CA\_Min < 2.5 \qquad [ Mathematical Formula 36 ]$$

CA11 is the effective length of the object-side surface of the first lens, for example, the effective length in the first direction, and CA_Min indicates the minimum effective length among the object-side surfaces and sensor-side surfaces of the lenses. When Mathematical Formula 36 is satisfied, the optical system may control incident light, maintain optical performance, and provide a slimmer module. Preferably, Mathematical Formula 36 may satisfy 1.4<CA11/CA_Min<2.

$$0.5 < CA\_Max / CA\_Min < 2.5 \qquad [ Mathematical Formula 37 ]$$

CA_Max indicates the maximum effective length among the object-side surfaces and sensor-side surfaces of the lenses, for example, the maximum effective length in the first direction. When Mathematical Formula 37 is satisfied, the optical system may maintain optical performance and set the size for a slim and compact structure. Preferably, Mathematical Formula 37 may satisfy 1.4<CA_Max/CA_Min<2.

$$1 < CA\_Max / CA\_Aver < 3 \qquad [ Mathematical Formula 38 ]$$

CA_Aver indicates the average of the effective lengths of the object-side surfaces and sensor-side surfaces of all lenses. When Mathematical Formula 38 is satisfied, the optical system may maintain optical performance and set the size for a slim and compact structure. Preferably, Mathematical Formula 38 may satisfy 1<CA_Max/CA_Aver<1.5.

$$10 < CA\_Max * nL < 30 \qquad [ Mathematical Formula 39 ]$$

nL is the number of lenses in the optical system, for example, 4. When Mathematical Formula 39 is satisfied, the optical system may set the maximum effective length according to the total number of lenses. Preferably, Mathematical Formula 39 may satisfy 20<CA_Max*nL<26.

$$0 < CA\_Max / ( 2 * ImgH ) < 1 \qquad [ Mathematical Formula 40 ]$$

Mathematical Formula 40 may be set by the maximum effective length of the lens surfaces (CA_Max) and the diagonal length of the image sensor, and when it is satisfied, the optical system may maintain good optical performance and set the size for a slim and compact structure. Preferably, it may satisfy 0.5<CA_Max/(2*ImgH)<1.

$$0.5 < T D / CA\_Max < 2 \qquad [ Mathematical Formula 41 ]$$

When Mathematical Formula 41 is satisfied, the total optical axis distance of the lenses TD and the maximum effective length of the lens surfaces may be set, thereby setting the size for good optical performance. Preferably, Mathematical Formula 41 may satisfy 0.8<TD/CA_Max<1.5.

$$0 < CT\_Max / TD < 0.5 \qquad [ Mathematical Formula 42 ]$$

In Mathematical Formula 42, the maximum center thickness among the lenses and the total optical axis distance of the lenses TD may be set, thereby improving good optical performance. Preferably, Mathematical Formula 43 may satisfy 0.2<CT_Max/TD<0.5.

$$2 < F / CA 51 < 8 \qquad [ Mathematical Formula 43 ]$$

F indicates the effective focal length EFL of the optical system, which may be greater than 7 mm. In Mathematical Formula 43, the relationship between the effective focal length and the effective diameter of the object-side surface of the last spherical lens may be set, thereby controlling the reduction of the optical system, for example, the influence on TTL. Preferably, Mathematical Formula 43 may satisfy 4<F/CA51<7.

$$1 < F / L 1 R 1 < 5 \qquad [ Mathematical Formula 44 ]$$

In Mathematical Formula 44, the effective focal length of the optical system and the curvature radius of the object-side surface of first lens may be set, thereby controlling the incident light and the influence on TTL. Preferably, Mathematical Formula 44 may satisfy 3<F/LIR1<5.

$$2 < Max ( C T / E T ) < 4 \qquad [ Mathematical Formula 45 ]$$

Max (CT/ET) indicates the maximum ratio of the center thickness to the edge thickness of each lens. When Mathematical Formula 45 is satisfied, the optical system may control the influence on the effective focal length. Preferably, Mathematical Formula 45 may satisfy 2<Max (CT/ET)<3.

$$1 < E P D / L 1 R 1 < 2 \qquad [ Mathematical Formula 46 ]$$

EPD means the size (mm) of the entrance pupil diameter of the optical system 1000. When the optical system 1000 satisfies Mathematical Formula 46, the optical system 1000 may control incident light. Preferably, Mathematical Formula 46 may satisfy 1.2<EPD/LIRI<1.8

$$0.5 < \vert F 1 / F 3 \vert < 2 \qquad [ Mathematical Formula 47 ]$$

F1 is the focal length of first lens, and F3 is the focal length of third lens. When Mathematical Formula 47 is satisfied, the power of first lens and third lens may be controlled to improve resolution and may affect TTL and effective focal length F. Preferably, Mathematical Formula 47 may satisfy 0.7<|F1/F3|<1.

$$F 1 < F 4 \qquad [ Mathematical Formula 47 - 1 ]$$

$$F 1 < \vert F 3 \vert \qquad [ Mathematical Formula 47 - 2 ]$$

$$\vert F 2 \vert < F 1 \qquad [ Mathematical Formula 47 - 3 ]$$

$$F 1 < F \qquad [ Mathematical Formula 47 - 4 ]$$

$$\vert F 3 \vert < F < F 4 \qquad [ Mathematical Formula 47 - 5 ]$$

In Mathematical Formulas 47-1 to 47-5, F1 is the focal length of first lens, F2 is the focal length of second lens, F3 is the focal length of third lens, and F4 is the focal length of fourth lens. By controlling the power of each lens, light may be guided through the aspheric lenses.

The aperture stop ST is arranged on the object-side surface of second lens 102. The focal length of the two lenses disposed on the sensor side relative to the aperture stop ST and positioned closest to the aperture stop ST is less than 0. In an embodiment of the present invention, the focal lengths F2 and F3 of the second lens and third lens may be designed to be less than 0. In this case, the sensor-side surface of third lens is concave, and the object-side surface of fourth lens has a concave shape, so the optical axis distance between third lens and fourth lens may be increased.

$$\vert Po 2 \vert < \vert Po 4 \vert < \vert Po 3 \vert \qquad [ Mathematical Formula 48 ]$$

Po2 is the power value of second lens, and Po4 is the power value of fourth lens. The power of fourth lens is positive, and the powers of second lens and third lens are negative, so the fourth lens may compensate for aberrations generated by second lens and third lens. In addition, first lens is a spherical lens and has positive refractive power, and second lens and third lens are aspheric lenses and have negative refractive power, so spherical aberration may be compensated.

$$15 < Vd 1 - Vd 3 < 60 \qquad [ Mathematical Formula 49 ]$$

Vd1 is the Abbe number of second lens 102, and Vd3 is the Abbe number of third lens 103. When Mathematical Formula 49 is satisfied, the difference in Abbe numbers between two adjacent lenses may be maintained above a certain value, thereby improving chromatic aberration. Mathematical Formula 49 may preferably satisfy 20<Vd1−Vd3<45.

$$1 < \vert F 24 / F 12 \vert < 5 \qquad [ Mathematical Formula 50 ]$$

In Mathematical Formula 50, the relationship between the combined focal length F12 of first lens 101 and second lens 102 and the combined focal length F24 of second lens 102 to fourth lens 104 is set, so that the power of each lens may be controlled to improve resolution, and the optical system 1000 may be provided with a slim and compact size. Mathematical Formula 50 may preferably satisfy 1<|F24/F12|<2.

$$0 < \vert F 24 / F \vert < 2 \qquad [ Mathematical Formula 51 ]$$

In Mathematical Formula 51, the relationship between the overall focal length F and the combined focal length F24 of second lens 102 to fourth lens 104 is set, so that the power of each lens may be controlled to improve resolution. Mathematical Formula 51 may preferably satisfy 0<|F24/F|<1.

$$0 < \vert F 34 / F 12 \vert < 2 \qquad [ Mathematical Formula 52 ]$$

In Mathematical Formula 52, the relationship between the combined focal length F12 of first lens 101 and second lens 102 and the combined focal length F34 of third lens 103 to fourth lens 104 is set, so that the combined power of each lens may be controlled to improve resolution. Mathematical Formula 52 may preferably satisfy 1<|F34/F12|<1.5, and F34>0, F12>0.

$$1 < \vert F 4 / F 13 \vert < 10 \qquad [ Mathematical Formula 53 ]$$

In Mathematical Formula 53, the relationship between the combined focal length F13 of first lens 101 to third lens 103 and the focal length F4 of fourth lens 104 is set. By setting the combined focal length of first to third lenses with large average effective length and the focal length of fourth lens 104 with small effective diameter within this range, the combined power of each lens may be controlled to improve resolution. Mathematical Formula 53 may preferably satisfy 3<|F4/F13|<7, and F4>0, F13>0.

$$1 < Fno < 4 \qquad [ Mathematical Formula 54 ]$$

Fno denotes the F-number of the optical system 1000. When Mathematical Formula 54 is satisfied, the brightness of the telephoto optical system may be controlled. Mathematical Formula 54 may preferably satisfy 2.4<Fno<3.

$$10 mm < TTL < 22 mm \qquad [ Mathematical Formula 55 ]$$

TTL (Total Track Length) refers to the distance along the optical axis OA from the center of the first surface S1 of first lens 101 to the surface of the image sensor 300. By setting TTL to exceed 10 mm in Mathematical Formula 55, a telephoto-type optical system may be provided. Mathematical Formula 55 may preferably satisfy 13 mm≤TTL≤20 mm.

$$2 mm < ImgH \qquad [ Mathematical Formula 56 ]$$

Mathematical Formula 56 sets half of the diagonal length of the image sensor 300, thereby defining the size of the image sensor for the telephoto optical system. Mathematical Formula 56 may preferably satisfy 3 mm<ImgH<4 mm.

$$5 mm < BFL < 12 mm \qquad [ Mathematical Formula 57 ]$$

In Mathematical Formula 57, BFL (Back Focal Length) is set to exceed 5 mm but be less than 12 mm, securing space for the optical filter 400 and the length required for a telephoto optical system. The distance between the image sensor 300 and the last lens allows improved assembly and coupling reliability. Mathematical Formula 57 may preferably satisfy 7 mm<BFL<11 mm. If BFL is below this range, some light reaching the image sensor may not be delivered to it, reducing resolution. If BFL exceeds this range, unnecessary light may enter, degrading the optical system's aberration characteristics. When BFL is large, as shown in FIG. 2, a second optical path control member 520 may be disposed between the image sensor 300 and fourth lens 104.

$$0 < CT\_Max / BFL < 0.5 \qquad [ Mathematical Formula 58 ]$$

Mathematical Formula 58 sets the relationship between the thickest center thickness within the lens unit and BFL. Mathematical Formula 58 may preferably satisfy 0.1<CT_Max/BFL<0.4. The center thickness of the first lens may be the largest within the lens unit.

$$7 mm < F < 35 mm \qquad [ Mathematical Formula 59 ]$$

The total effective focal length F in Mathematical Formula 59 may be set according to the telephoto optical system. Mathematical Formula 59 may preferably satisfy 8 mm<F<30 mm or 10 mm<F<25 mm.

$$8 ° < FOV < 40 ° \qquad [ Mathematical Formula 60 ]$$

In Mathematical Formula 60, FOV (Field of View) refers to the diagonal field angle (degree) of the optical system 1000, and may provide a telephoto optical system with FOV below 40°. Mathematical Formula 60 may preferably satisfy 15°<FOV<30°

$$1 < FOV / BFL < 4 \qquad [ Mathematical Formula 61 ]$$

In Mathematical Formula 61, FOV is set to be less than four times BFL to provide a telephoto optical system with FOV below 40°. Mathematical Formula 61 may preferably satisfy 2<FOV/BFL<4.

$$1 < F / BFL < 10 \qquad [ Mathematical Formula 62 ]$$

Mathematical Formula 62 sets the total effective focal length F of the optical system 1000 and the optical axis distance BFL between the image sensor 300 and the last lens. When the optical system 1000 satisfies Mathematical Formula 62, it may have the designed field of view and appropriate focal length, providing a telephoto-type optical system. In addition, the optical system 1000 may adjust the distance between the last lens and the image sensor 300 to achieve favorable optical characteristics at the peripheral region of the FOV. Mathematical Formula 62 may preferably satisfy 1<F/BFL<5.

$$1 < F / ImgH < 10 \qquad [ Mathematical Formula 63 ]$$

Mathematical Formula 63 sets the total effective focal length F of the optical system 1000 and the diagonal length ImgH from the optical axis of the image sensor 300. Such an optical system 1000 may provide improved aberration characteristics within a telephoto-type optical system. Mathematical Formula 63 may preferably satisfy 3<F/ImgH<7.

$$1 < F / EPD < 5 \qquad [ Mathematical Formula 64 ]$$

Mathematical Formula 64 sets the total effective focal length F of the optical system 1000 and the size of the entrance pupil EPD, thereby allowing control of the overall brightness of the optical system. Mathematical Formula 64 may preferably satisfy 2<F/EPD<3.5.

$$1 < BFL / TD < 2 \qquad [ Mathematical Formula 65 ]$$

Mathematical Formula 65 sets the relationship between the optical axis distance TD of the lenses in the optical system 1000 and the back focal length BFL. Accordingly, the optical system may maintain resolution while controlling the overall size. Mathematical Formula 65 may preferably satisfy 1.2<BFL/TD<1.8, and preferably TD<BFL. When the BFL/TD value exceeds 2, TD is designed relatively small compared to BFL, reducing the overall size of the optical system, which may degrade aberration characteristics or reduce resolution.

$$0 < EPD / ImgH / FOV < 0.2 \qquad [ Mathematical Formula 66 ]$$

Mathematical Formula 66 sets the relationship among the entrance pupil size EPD, half ImgH of the diagonal length of the image sensor, and the diagonal field angle FOV. Accordingly, the optical system may control the overall size and brightness. Mathematical Formula 66 may preferably satisfy 0<EPD/ImgH/FOV<0.1.

$$1 < FOV / Fno < 20 \qquad [ Mathematical Formula 67 ]$$

Mathematical Formula 67 sets the relationship between the diagonal field angle FOV of the optical system and the F-number Fno. Mathematical Formula 67 may preferably satisfy 5<FOV/Fno<15. Here, Fno may be provided below 3.0 to achieve bright imaging.

0.83<Fno1/Fno<0.98 [Mathematical Formula 68]

In an embodiment of the present invention, Fno is the F-number of the optical system when at least one lens among the first to third lenses has its edges cut along the second direction, and Fno1 is the F-number when all lenses have the same effective diameter in both first and second directions on their object-side and sensor-side surfaces. Mathematical Formula 68 may limit the size of the cut lenses.

$$[ Mathematical Formula 69 ]$$

$$Z = \frac{{cY}^{2}}{1 + \sqrt{1 - ( 1 - K ) {c}^{2} {Y}^{2}}} + {AY}^{4} + {BY}^{6} + {CY}^{8} + {DY}^{10} + {EY}^{12} + {FY}^{14} + …$$

In Mathematical Formula 80, Z may represent the distance along the optical axis from an arbitrary position on the aspheric surface to the vertex of the aspheric surface. Y may represent the distance from an arbitrary position on the aspheric surface to the optical axis in the direction perpendicular to the optical axis. c may represent the curvature of the lens, and K may represent the conic constant. In addition, A, B, C, D, E, and F may represent aspheric coefficients.

The optical system 1000 according to an embodiment may satisfy at least one or more of Mathematical Formulas 1 to 34. At least one or more of Mathematical Formulas 1 to 34 may satisfy at least one or more of Mathematical Formulas 35 to 68. In this case, the optical system 1000 may exhibit enhanced optical characteristics. Specifically, when the optical system 1000 satisfies at least one of Mathematical Formulas 1 to 34 and/or at least one of Mathematical Formulas 35 to 68, the optical system 1000 may have improved resolution and may reduce aberration and distortion. In addition, the optical system 1000 may secure the back focal length (BFL) for a telephoto optical system and provide good optical performance at both the center and periphery of the field of view (FOV).

Table 1 lists the parameters corresponding to the aforementioned Mathematical Formulas in the optical system 1000 according to an embodiment, including TTL (Total Track Length) in mm, BFL (Back Focal Length), effective focal length F in mm, ImgH in mm, optical axis distance TD from the first surface S1 to the eighth surface S8 in mm, the focal lengths F1, F2, F3, and F4 of the first to fourth lenses in mm, the sum of refractive indices, the sum of Abbe numbers, the sum of center thicknesses of each lens in mm, the sum of distances between adjacent lenses, the diagonal field of view FOV in degrees, edge thickness (ET), the focal lengths of the first and second lens groups, the composite focal length of the second to fourth lenses, and F-number.

TABLE 1

| Items | Values | Items | Values |
|---|---|---|---|
| F | 15.774 | ET1 | 0.7243 |
| F1 | 6.717 | ET2 | 0.9636 |
| F2 | −20.000 | ET3 | 1.2318 |
| F3 | −7.947 | ET4 | 1.3084 |
| F4 | 20.065 | ΣET | 4.228 |
| FLG1 | 3.82 | F# | 2.600 |
| FLG2 | 20.065 | FOV (Diagonal FOV) | 24.827 |
| F12 | 2.66 | EPD | 5.800 |
| F23 | 1.83 | BFL | 8.942 |
| F34 | 3.31 | TD | 6.158 |
| F13 | 3.82 | ImgH | 3.528 |
| ΣNd | 6.468 | SD | 3.494 |
| ΣVd | 140.63 | TTL | 15.100 |
| ΣCT | 4.995 | CA_Max | 5.800 |
| ΣCG | 1.163 | CA_Min | 3.467 |

Table 2 shows the results for Mathematical Formulas 1 to 34 and Mathematical Formulas 35 to 68 in the optical system 1000 according to an embodiment. Referring to Table 2, it can be seen that the optical system 1000 satisfies at least one, two, or three or more of Mathematical Formulas 1 to 34. It can also be seen that the optical system 1000 satisfies at least one, two, or three or more of Mathematical Formulas 35 to 68. Accordingly, the optical system 1000 may provide good optical performance at both the center and periphery of the field of view (FOV) and may exhibit excellent optical characteristics.

TABLE 2

| | |
|---|---|
| Mathematical Formulas | Values |

| | | |
|---|---|---|
| 1 | L1R1 > 0 | 4.005 |
| 2 | L4R2 < 0 | −11.196 |
| 3 | 2 < TLG1 / TLG2 < 5 | 2.678 |
| 4 | 0.50 < CAn2 / CA11 < 0.9 | Satisfaction |
| 5 | 5 < (CA41 + CA42) < 9 | 7.067 |
| 6 | 1.60 < Nd4 < 1.7 | 1.646 |
| 7 | 0 < nL_CAx ≠ nL_CAy < 4 | Satisfaction |
| 8 | 0.55 < CA11y / CA11x < 0.98 | Satisfaction |
| 9 | 1 < CT1 / CT4 < 3 | 1.346 |
| 10 | 0.1 < CG3 / CT123 < 0.5 | 0.255 |
| 11 | 0.3 < CG3 / CT4 < 1 | 0.637 |
| 12 | 1 < BFL / TLG1 < 3 | 2.339 |
| 13 | 4 < BFL / TLG2 < 8 | 6.265 |
| 14 | 1 < CA11 / CA41 < 3 | 1.673 |
| 15 | 0 < CA32 / CA41 < 2 | 1.011 |
| 16 | 0 < CA41 / CA42 < 2 | 0.963 |
| 17 | 1 < BFL / CA1 < 5 | 1.615 |
| 18 | 2 < BFL / CA4 < 5.5 | 2.531 |
| 19 | 7 < BFL / CG3 < 12 | 9.843 |
| 20 | 0.1 < TLG1 / TTL < 0.5 | 0.253 |
| 21 | 0 < TLG2 / TTL < 0.3 | 0.095 |
| 22 | 1 < \|L2R1 / L4R2\| < 3 | 2.648 |
| 23 | 5 < \|L4R1 / CT4\| < 12 | 7.845 |
| 24 | 0 < L3R2 / \|L4R1\| < 0.5 | 0.043 |
| 25 | 3 < \|L4R1 / L4R2\| < 10 | 6.968 |
| 26 | 1.5 < TTL / TD < 3 | 2.452 |
| 27 | 1 < TTL / CA_Max < 5 | 2.603 |
| 28 | 3 < TTL / ImgH < 6 | 4.28 |
| 29 | 1 < BFL / ImgH < 5 | 2.535 |
| 30 | 0.2 < BFL / TTL < 1 | 0.592 |
| 31 | 0.5 < TTL / F < 1.5 | 0.957 |
| 32 | 1 < CT_Max / CG_Max < 3 | 2.115 |
| 33 | 2 < ΣCT / ΣCG < 6 | 4.297 |
| 34 | 5 < ΣNd < 9 | 6.468 |
| 35 | 10 < ΣVd / ΣNd < 50 | 21.743 |
| 36 | 0.5 < CA11 / CA_Min < 2.5 | 1.673 |
| 37 | 0.5 < CA_Max / CA_Min < 2.5 | 1.673 |
| 38 | 1 < CA_Max / CA_Aver < 3 | 1.303 |
| 39 | 10 < CA_Max*nL < 30 | 23.2 |
| 40 | 0 < CA_Max / (2*ImgH) < 1 | 0.822 |
| 41 | 0.5 < TD / CA_Max < 2 | 1.062 |
| 42 | 0 < CT_Max / TD < 0.5 | 0.312 |
| 43 | 2 < F / CA41 < 8 | 4.55 |
| 44 | 1 < F / L1R1 < 5 | 3.939 |
| 45 | 2 < Max (CT/ET) < 4 | 2.653 |
| 46 | 1 < EPD/L1R1 < 2 | 1.448 |
| 47 | 0.5 < \|F1 / F3\| < 2 | 0.845 |
| 48 | \|Po2\| < \|Po4\| < \|Po3\| | Satisfaction |
| 49 | 15 < Vd1-Vd3 < 60 | 34.776 |
| 50 | 1 < \|F24 / F12\| < 5 | 1.563 |
| 51 | 0 < \| F24 / F \| < 2 | 0.264 |
| 52 | 0 < \|F34 / F12\| < 2 | 1.243 |
| 53 | 1 < \|F4 / F13\| < 10 | 5.249 |
| 54 | 1 < Fno < 4 | 2.8 |
| 55 | 10 < TTL < 22 | 15.1 |
| 56 | 2 < ImgH | 3.528 |
| 57 | 5 < BFL < 12 | 8.942 |
| 58 | 0 < CT_Max / BFL < 0.5 | 0.215 |
| 59 | 7 < F < 35 | 15.774 |
| 60 | 8 < FOV < 40 | 24.83 |
| 61 | 1 < FOV / BFL < 4 | 2.776 |
| 62 | 1 < F / BFL < 10 | 1.764 |
| 63 | 1 < F / ImgH < 10 | 4.471 |
| 64 | 1 < F / EPD < 5 | 2.72 |
| 65 | 1 < BFL / TD < 2 | 1.452 |
| 66 | 0 < EPD/Imgh/FOV < 0.2 | 0.066 |
| 67 | 1 < FOV / Fno < 20 | 8.867 |
| 68 | 0.83 < Fno1 / Fno < 0.98 | Satisfaction |

FIG. 10 is a diagram illustrating a camera module applied to a mobile terminal according to an embodiment. As shown in FIG. 10, the mobile terminal 1500 may include a camera module 1520 provided on a front or rear surface, a flash module 1530, and an auto-focus device 1510. Here, the auto-focus device 1510 may include a surface-emitting laser device and an optical receiving unit as a light-emitting layer disclosed herein. The flash module 1530 may include an emitter that emits light therein. The flash module 1530 may operate according to the camera operation of the mobile terminal or user control. The camera module 1520 may include an image capturing function and an auto-focus function. For example, the camera module 1520 may include an image-based auto-focus function.

The auto-focus device 1510 may include a laser-based auto-focus function. The auto-focus device 1510 may be primarily used under conditions where the image-based auto-focus function of the camera module 1520 is degraded. Although not shown in the drawings, at least one additional camera module may also be disposed on the front of the mobile terminal 1500. At least one of the camera modules in the mobile terminal may have the tele-type folded optical system disclosed herein. The optical system or camera module according to an embodiment of the invention may be applied to electronic devices using lens assemblies according to various embodiments, for example, devices employing an image sensor. Exemplary lens assemblies according to embodiments may be applied to digital cameras, interchangeable-lens cameras, video cameras, mobile phone cameras, cameras for small mobile devices, VR, AR, drones, or manned/unmanned aerial vehicles, among various electronic devices.

The features, structures, and effects described in the above embodiments are included in at least one embodiment of the present invention and are not necessarily limited to a single embodiment. Furthermore, the features, structures, and effects exemplified in each embodiment may be combined or modified for other embodiments by those of ordinary skill in the art to which the embodiments pertain. Accordingly, such combinations and modifications should be construed as being within the scope of the present invention. In addition, although the above description focuses on embodiments, this is merely illustrative and does not limit the invention, and those of ordinary skill in the art may recognize that various modifications and applications not exemplified above are possible without departing from the essential characteristics of the embodiments. For example, each component specifically shown in the embodiments may be modified and implemented. Differences related to such modifications and applications should be construed as included within the scope of the present invention as defined by the appended claims.

1.-15. (canceled)

16. An optical system comprising:
a first lens to fourth lens arranged sequentially along an optical axis from an object side,
wherein an object-side surface of the first lens has a convex shape on the optical axis,
wherein a sensor-side surface of the first lens has a concave shape on the optical axis,
wherein a sensor-side surface of the fourth lens has a convex shape on the optical axis,
wherein the first lens is made of glass, and the object-side surface and the sensor-side surface of the first lens are spherical,
wherein a center distance between the third lens and the fourth lens among center distances between the first to fourth lenses is a largest,
wherein an optical axis distance from the object-side surface of the first lens to a surface of an image sensor is TTL,
wherein an optical axis distance from the sensor-side surface of the fourth lens to the surface of the image sensor is BFL,
wherein an optical axis distance from the object-side surface of the first lens to the sensor-side surface of the fourth lens is TD, and
wherein the following Mathematical Formulas satisfy: 0.2<BFL/TTL<1 and 1<TTL/TD<2.

17. The optical system of claim 16, wherein a center thickness of the fourth lens is thicker than center thicknesses of the second and third lenses,
wherein a center thickness of the first lens is CT1,
wherein the center thickness of the fourth lens is CT4, and
wherein the following Mathematical Formula satisfies: 1<CT1/CT4<3.

18. The optical system of claim 16, wherein a total focal length of the optical system is F, and
wherein the following Mathematical Formulas satisfy: 0.5<TTL/F<1.5 and 7 mm<F<35 mm.

19. The optical system of claim 16, wherein a half of the diagonal length of the image sensor is ImgH, and
wherein the following Mathematical Formulas satisfy: 3<TTL/ImgH<6 and 1<BFL/ImgH<5.

20. The optical system of claim 16, wherein the fourth lens has positive power,
wherein effective diameters of object-side surface and sensor-side surface of the fourth lens are CA41 and CA42, and
wherein the following Mathematical Formula satisfies: 5 mm<(CA41+CA42)<9 mm.

21. The optical system of claim 16, wherein the object-side surface and the sensor-side surface of the first lens have a maximum effective length in a first direction that is longer than effective diameters of an object-side surface and the sensor-side surface of the fourth lens in the first direction,
wherein at least one of the first to third lenses has a maximum effective length in a second direction orthogonal to the first direction that is smaller than a maximum effective length in the first direction, and
wherein the first and second directions are orthogonal to the optical axis.

22. The optical system of claim 21, wherein the maximum effective length of the object-side surface of the first lens in the first direction is CA11x,
wherein the maximum effective length of the object-side surface of the first lens in the second direction is CA11y, and
wherein the following Mathematical Formula satisfies: 0.55<CA11y/CA11x<0.98.

23. The optical system of claim 22, wherein an effective diameter of the sensor-side surface of the fourth lens is CA42, and
wherein the following Mathematical Formula satisfies: 0.50<CA42/CA11<0.9.

24. The optical system of claim 16, wherein a sum of the center thicknesses of the first, second, and third lenses is CT123,
wherein a sum of the center thicknesses of the fourth lens is CT4,
wherein a center distance between the third and fourth lenses is CG3, and
wherein the following Mathematical Formulas satisfy: 0.1<CG3/CT123<0.5 and 0.3<CG3/CT4<1.

25. The optical system of claim 16, wherein the first to third lenses have a meniscus shape convex toward the object on the optical axis, and
wherein the fourth lens has a meniscus shape convex toward the sensor on the optical axis.

26. The optical system of claim 16, wherein the first lens has positive power,
wherein a center thickness of the first lens is CT1,
wherein the center distance between the first and second lenses is CG1, and
wherein the following mathematical formula satisfies: 10<CT1/CG1<50.

27. The optical system of claim 16, wherein a composite focal length of the first and second lenses is F12,
wherein a composite focal length of the third and fourth lenses is F34, and
wherein the following mathematical formula satisfies: 0<|F34/F12|<2.

28. The optical system of claim 16, wherein a focal length of the first lens is F1,
wherein a focal length of the fourth lens is F4, and
wherein the following mathematical formula satisfies: F1<F4.

29. The optical system of claim 16, wherein an effective length of the object-side surface of the first lens is CA11,
wherein an effective length of the object-side surface of the fourth lens is CA41, and
wherein the following mathematical formula satisfies: 1<CA11/CA41<3.

30. An optical system comprising:
a first lens having positive refractive power;
a second lens disposed on a sensor side of the first lens;
a third lens disposed on a sensor side of the second lens; and
a fourth lens disposed on a sensor side of the third lens, having positive refractive power and a convex shape on a sensor-side surface,
wherein the first to fourth lenses are aligned with an optical axis,
wherein an object-side surface of the first lens has a convex shape on the optical axis,
wherein a sensor-side surface of the first lens has a concave shape on the optical axis,
wherein a sensor-side surface of the fourth lens has a convex shape on the optical axis, and
wherein a center distance between the third lens and the fourth lens among center distances between the first to fourth lenses is a largest.

31. The optical system of claim 30, wherein the first lens is a spherical lens made of glass, and
wherein the second to fourth lenses are aspherical lenses and have a material different from that of the first lens.

32. The optical system of claim 30, further comprising:
a first optical path control member disposed on the object side of the first lens; and
an image sensor disposed on the sensor side of the fourth lens,
wherein an optical axis distance from the object-side surface of the first lens to a surface of the image sensor is TTL,
wherein an optical axis distance from the sensor-side surface of the fourth lens to the surface of the image sensor is BFL,
wherein an optical axis distance from the object-side surface of the first lens to a sensor-side surface of the third lens is TLG1,
wherein a center thickness of the fourth lens is TLG2, and
wherein the following Mathematical Formulas satisfy: 0.2<BFL/TTL<1 and 2<TLG1/TLG2<5.

33. The optical system of claim 30, wherein a center distance between the third lens and the fourth lens is a largest among the center distances among the other lenses,
wherein the second and third lenses have negative power,
wherein the center distance between the third lens and the fourth lens is CG3, and
wherein the following Mathematical Formula satisfies: 7<BFL/CG3<12.

34. A camera module comprising:
an optical system having a plurality of lenses; and
an optical filter disposed between the optical system and an image sensor,
wherein the optical system comprises the optical system of claim 16,
wherein at least one lens adjacent to the object an among the lenses of the optical system has different lengths in two orthogonal directions,
wherein an optical axis distance from the object-side surface of the first lens to a surface of the image sensor is TTL,
wherein an optical axis distance from the sensor-side surface of the fourth lens to the surface of the image sensor is BFL,
wherein a half of the diagonal length of the image sensor is ImgH, and
wherein the following Mathematical Formulas satisfy: 1<BFL/ImgH<5 and 3<TTL/ImgH<6.

35. The camera module of claim 34, wherein the first lens has positive power, and
wherein the second and third lenses have negative power.
